(19) United States
(12) Patent Application Publication
(10) Pub. No.: US 2003/0004929 A1
(43) Pub. Date: Jan. 2, 2003

(54) Method and apparatus for a computer-implemented system for the maintainence of a business relationship between a seller and a buyer

(76) Inventors: Arnold James Julian IV, Ellwood City, PA (US); Antonine Miller, Oakdale, PA (US); Dewey W. Renner, Spraggs, PA (US); John Heaton, Pittsburgh, PA (US); Hemant Chauhan, Pittsburgh, PA (US); Beth A. Matthews, McMurray, PA (US)

Correspondence Address: BAYER CORPORATION, PATENT DEPARTMENT, 100 BAYER ROAD, PITTSBURGH, PA, 15205, US

(21) Appl. No.: 09/882,282

(22) Filed: Jun. 15, 2001

(51) Int. Cl. G06F 17/30

(52) U.S. Cl. 707/2

(57) ABSTRACT

Disclosed is a computer-implemented method for maintaining a business relationship between a seller (i.e., a first entity) and a buyer (i.e. a second entity). The method includes the steps of: a) providing a central database of information that contains disparate buyer data on a first entity network; b) establishing a buyer access level function on a first entity network, wherein the buyer level function allows the first entity to provide a buyer with access to a set of buyer data and a set of buyer functions for structuring the set of buyer data; c) establishing a gatekeeper level function that provides access at a gatekeeper buyer contact point on a buyer network to the set of buyer data from the database and the set of buyer functions; and d) establishing a buyer subordinate level user function at a buyer subordinate level user contact point that provides a buyer subordinate level user with access to selected buyer data from the set of buyer data and selected functions from the selected buyer functions at the buyer subordinate level user contact point. Also disclosed is an apparatus that is capable of performing this method.

### BACKGROUND OF THE INVENTION

1. Field of the Invention

The present invention relates generally to business relationship methods, and, in particular, to a computer-implemented automated system for maintaining a business relationship between a seller and a buyer.

2. Description of the Prior Art

Automated systems for maintaining and developing the relationship between a seller and a buyer are increasing in importance in the present economy. As technology develops, computer-implemented systems are required to define these relationships, especially between a seller and multiple buyers. With increased options available to a buyer of goods and services, increased value is placed on a full-service, flexible and customer-oriented system. Such a system will assist in defining, maintaining and developing the relationship between the seller and the buyers. Further, the more user-specific the system, the more the individual user values and utilizes the system.

Such a user-tuned or user-specific system is shown in U.S. Pat. No. 6,195,651 to Handel et al. The '651 patent discloses a system that provides a web-based user interface to a user based upon the user's profile information. The system of the '651 patent uses a pattern matching routine to process and match web-based content and present this content in a user-specific fashion. However, the system of the '651 patent lacks the ability to ensure that a user will view the precise information that he or she wishes to view. In addition, the '651 system does not allow the user to dynamically adjust and modify the type and format of data that he or she wishes to view.

Another example of a system that defines a relationship between trading partners is shown in U.S. Pat. No. 6,226,675 to Meltzer et al. The '675 patent discloses a participant server which processes documents in commerce in and between trading partner networks. Using business interface definitions, trading partners can place orders and check status and inventory levels. While the system of the '675 patent facilitates the information exchange between a buyer and a seller, such a system lacks the dynamic adjustability and customizable presentation of information required for specifically meeting any individual customer's needs.

U.S. Pat. No. 6,182,142 to Win et al. is directed to distributed access management of information resources. The system of the '142 patent controls information resources, allowing an individual user access to only authorized resources and data. The access privilege and level of the user depends upon his or her role and/or functional grouping. Using encrypted tokens that define the user's role and functional grouping, the system stores the tokens and presents the user with a customized display, showing only those resources or data to which the user has authorized access. While the system of the '142 patent presents customized information based on the user access level, this system lacks the dynamic adjustment at the user or customer interface.

U.S. Pat. No. 6,226,656 to Zawadzski et al. discloses a system for creating, generating and processing user-defined generic specs. The system of the '656 patent allows users to access a central database of information via the Internet, and uses a page builder to build and present a custom page to the user via a web browser. The display of the page depends upon the user's answers to questions and selections. A customized output of information is provided to the user wherein the system sets flags and turns options on and off depending upon the user's answers and selections. The system of the '656 patent is limited in use and only provides predetermined product information to the user in a customer-chosen format. The customer is limited in access, and the system is not dynamic at its root.

The prior art lacks the ability to present disparate customer data in a truly dynamic fashion. Also lacking is the ability to delegate individual user access designation to the customer or buyer side, which is required for a fully functional and customizable networked system. Each individual user dynamic functionality and authorized access level should be prescribed at the buyer end, and the buyer itself must also have seller-authorized access. In addition, there remains a need for not only dynamic customizability on the buyer end, but this dynamic customizability must provide information that is, itself, dynamic. Further, each individual user should be able to customize his or her authorized data in a customizable format to his or her choosing.

### SUMMARY OF THE INVENTION

It is therefore an object of the present invention to provide a system that can present disparate buyer data to an authorized buyer. It is another object of the present invention to provide a system that provides a framework for dynamically structuring form and content of data. It is another object of the present invention to provide a system that delegates, at the customer end, the ability for the buyer to determine each individual user's dynamic functionality and individual authorized access level. It is yet another object of the present invention to provide a system that allows access and customization at the user end to information that is likewise dynamic. It is a still further object of the present invention to provide a system which allows the individual user to select the data and presentation of the data in a fully customizable fashion.

Accordingly, in order to overcome the deficiencies of the prior art, we have invented a computer-implemented automated system for maintaining a business relationship between a seller (i.e., a first entity) and at least one buyer (i.e., a second entity). According to the present invention, there is provided a method and apparatus for an automated system for maintaining a business relationship between a seller and a buyer.

A method according to the present invention includes the steps of: (a) providing a database of information that contains disparate buyer data on a seller network; (b) establishing a buyer access level function on a seller network, wherein the buyer access level function allows the seller to provide a buyer with access to a set of buyer data from the database and a set of buyer functions for structuring the set of buyer data; (c) establishing a gatekeeper level function that allows the provision of a gatekeeper buyer contact point on a buyer network with the set of buyer data from the database and the set of buyer functions; and (d) establishing a buyer subordinate level user function that allows the provision of a buyer subordinate level user contact point that provides a buyer subordinate level user with access to selected buyer data from the set of buyer data and selected functions from the set of buyer functions at the buyer subordinate level user contact point.

We have also developed an apparatus that is capable of performing the above-described method. The present invention, both as to its construction and its method of operation, together with the additional objects and advantages thereof, will best be understood from the following description of specific embodiments when read in connection with the accompanying drawings.

### BRIEF DESCRIPTION OF THE DRAWINGS

FIG. 1 is a flow diagram illustrating the general method according to the present invention;

FIG. 2 is a block diagram illustrating a system embodying the method of FIG. 1;

FIGS. 3-53 are a series of screen shots of an example embodiment according to the method of the present invention; and

FIGS. 54-84 are a series of screen shots and field charts of an example embodiment according to the present invention.

### DETAILED DESCRIPTION OF THE PREFERRED EMBODIMENTS

The present invention provides an automated interface tool for managing the functional relationships between a seller and a buyer, and a buyer's access to buyer information on a seller network, as well as access and functionality of individual users on a buyer's network. The present invention is useful in both the macro-management and the micro-management of buyer data, down to the granularity of singular data fields.

This method presents an automated system for maintaining a business relationship between a seller and a buyer. Initially, while the terms “seller” and “buyer” are used, these terms are envisioned to include any relationship where the parties engage in the transactional exchange of information. For example, the “seller” may also be termed as a provider of a large data warehouse of information, which includes data that is specific to the second party. Therefore, a “seller” may be a corporate entity, an employer, an affiliate, a seller agent, etc. Similarly, the “buyer” may be a corporate entity, an employee, a subsidiary, a buyer agent, a user, an administrator, etc. A key factor of the relationship between the parties is defined by the collection, retention and dispensation of a database of information by the seller, and the administration, authorization, and presentation of some or all of the information to the buyer. The present method is equally useful for a first entity and a second entity engaging in some transactional exchange of information.

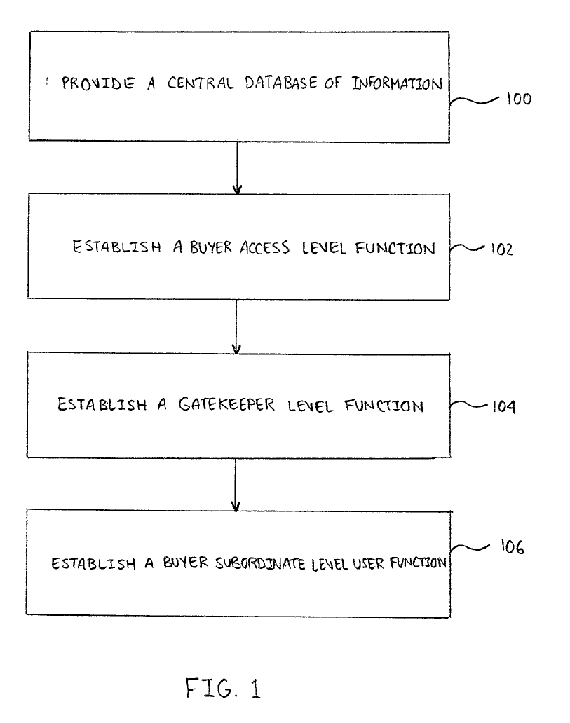

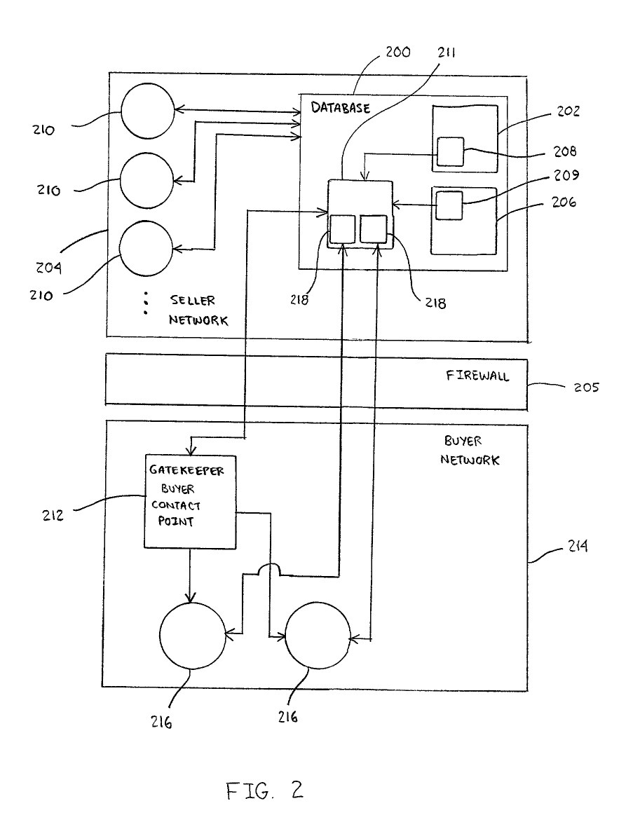

FIG. 1 is a flow diagram illustrating the method according to the present invention, and FIG. 2 is a block diagram illustrating a system according to the method.

Referring to FIGS. 1 and 2, a first step 100 provides a database 200 of information that contains disparate buyer data 202 and resides on a seller network 204. As illustrated in FIG. 2, the central database 200 resides on the seller network 204, and it is maintained in a secured environment, ultimately only modifiable by the seller or seller agent. This secured environment is typically maintained through the use of a firewall 205. The central database 200 is a vast collection of information, including seller-specific data 206 and files, together with buyer-specific data 208 and information. The buyer-specific data 208 includes all buyer and customer information relating to the relationship and transactional occurrences between the seller and the buyer, e.g., data pertaining to contracts, contacts, sales, shipping, inventory, Certificates of Analysis, logistical tracking, invoices, order history, etc. The seller network 204 may provide information from a variety of sources and networks, e.g., connected third party networks, common access networks and other data source networks.

Also included in the central database 200 is seller information 209 that may be of interest to the buyer for tracking and other informational purposes, e.g., seller inventory levels, product availability, Material Safety Data Sheets, etc. This central database 200 is resident on the seller network 204, which includes multiple data feeds, multiple databases, multiple seller-affiliated sub-networks and multiple operating platforms (e.g., Microsoft Windows, Unix, etc).(collectively referred to by reference number 210), all accessible by and in communication with the central database 200.

In a preferred embodiment, the central database 200 includes a set of Oracle® tables, which use a foreign key infrastructure (or other relational database structure) to correctly store and associate each individual data field, and each linked group of data fields. While Oracle®-type data association is preferred, any database organizational structure platform is envisioned. At a base level, a key requirement is that the central database 200 can be parsed for the buyer-specific information 208, i.e., information that is associated or linked to the buyer, and can also be parsed for buyer-authorized seller information 209, i.e., information to which the seller wishes to grant the buyer access.

The disparate buyer data 202 may include multiple customers, multiple product lines and multiple products. This data 202 is unrelated, except for its links to the specific buyer, and housed in the many databases and networks that feed and create the central database 200 on the seller network 204. It is envisioned that this central database 200 can be truly dynamic, offering the buyer real-time access to the buyer-specific data 208 and buyer-authorized seller data 209. While this may be useful in some instances, e.g., Certificates of Analysis, it may be inefficient to provide such dynamic access for all of the data, e.g., current buyer ship-to contact information. In choosing which data should be updated and maintained on the central database 200 in a dynamic relationship with the buyer, the seller must take into account the operable inefficiencies and resulting data bottle-necks that may occur with such flexibility. Therefore, while it is certainly envisioned that all data is offered to the buyer in real-time, it is preferred to “update” relatively static information on a more periodic basis.

In a second step 102, a buyer access level function is established, typically on the seller network 204. In establishing the buyer access level function, a seller is allowed to provide a buyer with access to a set of buyer data 211 (containing the buyer-specific data 208 and the buyer-authorized seller data 206) from the central database 200. Further, in this step 102, the seller is allowed to provide a buyer with access to a set of buyer functions for structuring the set of buyer data 211. Importantly, while the set of buyer data 211 may contain all data on the seller network 204 that is related to the buyer, it may be limited by the seller to only the specific buyer data deemed useful to the buyer. For example, it would be both non-useful and an inefficient use of central database 200 space and structure to provide the buyer with access to exceedingly outdated data. However, if the buyer wished to have access to this information, to the extent it was still available somewhere in the seller network 204, the seller could “call” the information to the central database 200, and make the information available to the buyer.

The buyer level access function provides a portal for the customer, e.g., the buyer corporate entity, affiliated user groups, multiple users. This portal has a defined identity, which is defined by the access level. Overall, the buyer level access function is the ability of the seller to associate and provide the set of buyer data to the buyer.

The set of buyer data 211 and the set of buyer functions is determined by the seller, but is not pre-determined. This set of buyer data 211 and set of buyer functions is dynamically adjustable by the seller, and requires neither specialized nor technical knowledge for modification or revocation. In doing so, the present method is particularly useful in a large corporate seller network 204, where an administrator can modify the set of buyer data 211 and set of buyer functions at his or her terminal, without the need to “program” or “code” in the classic sense. This, in turn, creates a flexible, useful and dynamic functional aspect to the present invention.

The set of buyer functions is the functionality required to define and maintain a transactional relationship between a seller and a buyer. For example, one of the functions available with the set of buyer functions is the ability to define the format in which the buyer would like the set of buyer information presented. These buyer functions give the buyer the functional capability to arrange, add, remove, organize and present buyer data 211 in any form that the buyer wishes.

The next step, step 104, includes establishing a gatekeeper level function that allows the provision of a gatekeeper buyer contact point 212 on a buyer network 214. This gatekeeper level function allows the gatekeeper buyer contact point 212 access to the set of buyer data 211 and the set of buyer functions. In essence, the “gatekeeper” and the gatekeeper level function is the provision of authorization, definition and access to the set of buyer data 211 and the set of buyer functions, as allowed by the seller. The provision of the gatekeeper level function may occur on the seller network 204 or on the buyer network 214, as long as the functional aspect of the gatekeeper is provided to and limited to the buyer network 214. While multiple gatekeeper buyer contact points 212 may be created, it is typically not preferable to provide such system administrator status to more than one gatekeeper buyer contact point 212 for integrity management reasons.

Step 104 may be thought of as the seller providing top-level or system administrator access to the buyer as to the set of buyer data 211 and set of buyer functions. Since the gatekeeper level function is typically provided by the seller, the gatekeeper is limited in scope, access and authority to the levels and data as established by the seller. This prevents the gatekeeper from accessing data or functionality that the seller deems to be outside of his or her scope or authority.

Finally, step 106 entails establishing a buyer subordinate level user function that allows the provision of a buyer subordinate level user contact point 216. This buyer subordinate level user contact point 216 provides a buyer subordinate level user with access to selected buyer data 218, as selected from the set of buyer data 211, and selected buyer functions, as selected from the set of buyer functions. Both the selected buyer data 218 and selected buyer functions are provided at the buyer subordinate level user contact point 216.

Either the seller or the gatekeeper may provide a buyer subordinate level user contact point 216. In the preferred embodiment, the gatekeeper provides the buyer subordinate level user contact point 216. This allows the buyer, through the buyer gatekeeper, to manage the flow and distribution of buyer data to each individual buyer user. For example, the buyer may wish each salesperson to have access to the sales data, but not the financial accounting data. Therefore, the buyer gatekeeper can restrict access at the buyer subordinate level user contact point 216 according to each user's role and responsibility.

It is envisioned that either the gatekeeper or the seller may provide a plurality of subordinate level user contact points 216. In this manner, the gatekeeper can manage multiple users, and define their flow of information, access to buyer data and interrelationships. Further, it may be useful to establish “groups” of users, e.g., the sales group, the accounting group, the shipping group, etc. Each individual user may have the same access to the selected buyer data 218 and selected buyer functions at different buyer subordinate level user contact points 216. The present method allows the buyer to establish and manage groups of users, assign project groups, define access levels and permit individualized functionality.

At the first (or subsequent) buyer subordinate level user contact point 216, each individual user has a defined, yet versatile, set of selected buyer functions, which the individual user may use to organize, manage and present the selected buyer data 218. For example, if a user in the laboratory would like to view a report matching the Certificate of Analysis for a product to a specific product shipment, that user is able to select the appropriate data fields and dynamically access the buyer data required to view such a report. Importantly, the user-selected data for the report must be a subset of the selected buyer data 218 which the individual user has permission to view. Further, the selected buyer data 218 is a subset of the set of buyer data 211, as determined by the gatekeeper or seller, and, in turn, the set of buyer data 211 is a subset of the central database 200 of information. The present method is advantageous in that, if the gatekeeper would like to revoke, modify or expand access for an individual user, he or she may do so on the buyer network 214, with little or no need for technical support from the seller. This functionality drastically increases the versatility of the system, and its usefulness to the buyer.

If authorization and permission is present, an individual user has total control over the customization and presentation of the selected buyer data 218. One particular advantage of the present invention is the dynamic nature of the disparate buyer data 202. As discussed above, the individual user, to the extent authorized, has access to the selected buyer data 218 directly at the central database 200 on the seller network. This allows the user to dynamically track any number of data streams and follow any data modifications. For example, this dynamic data access would allow a user in a shipping/receiving department to track an incoming shipment from the seller, thereby allowing the user to more effectively logistically manage and prepare for the shipment.

This same method is employed with multiple buyers, typically business entities. Since the central database 200 is maintained on the seller network 204, all buyer-specific data 208 is secure from access by other buyers (and competitors). Further, maintenance of the central database 200 on the seller network 204 still allows for the seller to manage all buyer data 202.

Another advantage of the method is the ability of the individual user to restrict or filter his or her own access or function. This allows the user to select subsets of the selected buyer data 218. While the individual user may further restrict his or her access to the selected buyer data 218, the user is not authorized to “expand” his or her access beyond the selected buyer data 218 and selected buyer functions, as set by the gatekeeper. Similarly, this is equally applicable to the gatekeeper, who can limit, but cannot expand access beyond the set of buyer data 211 and set of buyer functions, as set by the seller.

Customer modifications and additions can be made quickly and efficiently in the present system. Whereas, in the prior art, making a customer modification or addition to a large networked system of this type may take days or weeks, and require considerable additional coding, making such changes or modifications in the present system takes minutes. This quickness evolves from the simple and dynamic nature of the present invention, together with the lack of a requirement of a “technical” or “programming” background. Overall, the present system provides a dynamic control for tracking customer changes between the actual business relationship and the virtual business relationship. This control maintains 100% integrity between the actual business relationship and its virtual reflection. Further, this control provides the necessary flexibility for event modification and the transition between the actual and virtual business relationship. As discussed above, the central database 200 contains predetermined seller-specific data 206 and buyer-specific data 208. The buyer-specific data 208 is information relating to the relationship and transactional occurrences between the seller and the buyer thereby defining an event between the seller and the buyer.

In a particularly advantageous manner, the present invention provides a feature referred to as “relationship framework functionality.” This relationship framework functionality is a particularly advantageous way for allowing the seller to provide the buyer with access to the set of buyer data 211 and the set of buyer functions for structuring the set of buyer data 211. The relationship framework functionality generally includes: (1) a report relationship structure module field that defines generic features of events that are expected to occur in a relationship between a buyer and a seller; and (2) at least one database, electronically connected to the report relationship structure module field, that provides content for defining specific features of a specific event that actually occurs between a buyer and seller. The report relationship structure module field can define any generic feature or features of the events that are expected to occur during the course of the buyer-seller relationship. The at least one database electronically connected to the report relationship structure module field can include any database that can provide content for events that occur between the buyer and the seller. The report relationship structure module field interacts with the corresponding database or databases and generates reports that document events that occur in the relationship of the buyer and the seller.

In use, when the buyer access level function is established on a seller network, the buyer level function allows the seller to provide a buyer with access to reports, generated by the relationship framework functionality. These reports conveniently summarize events that occur in the buyer-seller relationship. In turn, the corresponding gatekeeper level function provides access at a gatekeeper buyer contact point 212 on the buyer network 214 to the reports that are generated by the relationship framework functionality. Further, the buyer subordinate level user function at the buyer subordinate user contact point 216 can provide a buyer subordinate level user with access to the reports generated by the relationship framework functionality. In view of the buyer having access to such reports, a buyer can now easily keep track of events that actually occur in a buyer-seller relationship. Also, since the relationship framework functionality can be modified to accommodate changes in a buyer-seller business relationship, a buyer can now easily keep track of changes that actually occur in a buyer-seller relationship.

As discussed above, events that occur in the actual business relationship are reflected in the virtual business relationship via the method of the present invention. However, the present system further allows for the dynamic presentation of selectable data to the buyer through the relationship framework functionality. As opposed to offering static disparate buyer data 202 to the buyer in a rigid format, the relationship framework functionality allows the system to reflect events that occur in the actual business relationship in the virtual business relationship, together with the ability to present the event data in selectable, dynamic fashion. For example, truly flexible and dynamic reporting occurs under this functionality, and the reports or data presentations are easily created without additional coding. This functionality allows an event to be created and defined between the seller and the buyer. Corresponding selected buyer data 218 for defining the event is selected and formatted in a presentable report, for presentation to the buyer. Either the seller or the buyer can define the event.

It is this relationship framework functionality that deconstructs the prior art data presentation systems. This deconstruction occurs between the format and the presentable data. Typically, a data presentation system will allow a user to “select” from a rigid or static set of form reports. The functionality of the present system tracks and provides only authorized data to a user in a fully-customizable format. As opposed to requiring a customer to send a request for a new report to a programmer, and a programmer creating the report, the present system automatically receives the customer request, filters the data (for authorization), allows the seller to construct a customized report format based on the authorized data, and presents the customized report to the customer. The relationship framework functionality allows a non-technical person to easily construct this customized report without any additional coding.

### EXAMPLE 1

In a specific example of the method according to the present invention, S Corp. is the seller and B Corp. is the buyer. S Corp. maintains, on its network, a large database of information containing disparate buyer data, including buyer data specifically concerning B. Corp. The S Corp. network has multiple data feeds and is an affiliation of many S Corp sub-networks. One of the S Corp. sub-networks is the S Corp. Plant network, located across the country from the S Corp. headquarter location, where the central database resides.

B Corp. has decided continue its use of S Corp. since S Corp. provides dynamic accessibility to B Corp. buyer data. At this point, S Corp., typically an S Corp. employee, such as a system administrator, establishes a B Corp. access level function, allowing the system administrator to provide B Corp. with access to a set of B Corp. data and a set of B Corp. functions. Since B Corp. is a long-time customer of S Corp., the system administrator decides to limit the set of B Corp. data to the last ten years of collected B Corp. data. The system administrator also provides B Corp. with a set of B Corp. functions, which allow B Corp. to structure, choose, manipulate and present the B Corp. data.

Next, the S Corp. system administrator establishes a gatekeeper level function, either on the S Corp. network or the B Corp. network. This gatekeeper level function allows B Corp., again, typically the B Corp. system administrator, access at a gatekeeper B Corp. contact point on the B Corp. network. Additionally, this gatekeeper level function provides the B Corp. system administrator access to the B Corp. data and B Corp. functions, as decided and established by the S Corp. system administrator. For security and accountability reasons, B Corp. has requested that only one person (or role) be appointed as the gatekeeper, although, if chosen, multiple gatekeepers may be appointed.

The B Corp. system administrator, as the gatekeeper, then establishes, on the B Corp. network, multiple B Corp. subordinate level user functions at corresponding B Corp. subordinate level user contact points, typically the user's computer access points. The gatekeeper provides, at these contact points, access to selected B Corp. data, as selected from the set of B Corp. data, and to selected B Corp. functions, again as selected from the set of B Corp. functions.

The B Corp. system administrator decides to provide the manager of shipping and receiving access to both the B Corp. shipping data and the B Corp. Certificates of Analysis for each shipment. Since the manager of shipping and receiving has minimal need for any financial data, the B Corp. system administrator decides to permit no access to the manager for this financial data. Therefore, the shipping data and the Certificates of Analysis are the selected data to which the manager has access to at his or her contact point.

As the manager is expecting a shipment from S Corp., and would like to view the Certificate of Analysis for the product being shipped, the manager decides to access the S Corp. system at the manager's contact point. The manager logs on to his or her computer and access his or her S Corp. web page. Since the gatekeeper has limited the manager's data access and functionality, the manager only views on the S Corp. web page that data and function to which he or she has access.

The manager “runs” a report listing all incoming S Corp. shipments, including the “ship to”, “product”, “expected arrival date”, and “Certificate of Analysis for the product” fields. This report or call is routed through the B Corp. network, to the S Corp. network, and draws information from the central database on the S Corp. network. While the “ship to” B Corp. data is updated on a weekly basis, the “product”, “expected arrival date” and “Certificate of Analysis” data is updated and dynamically available to B Corp. on an hourly basis. The appropriate data is searched, linked and routed to the manager's computer, thereby providing the manager with up-to-date and accurate information on any S Corp. shipment.

### EXAMPLE 2

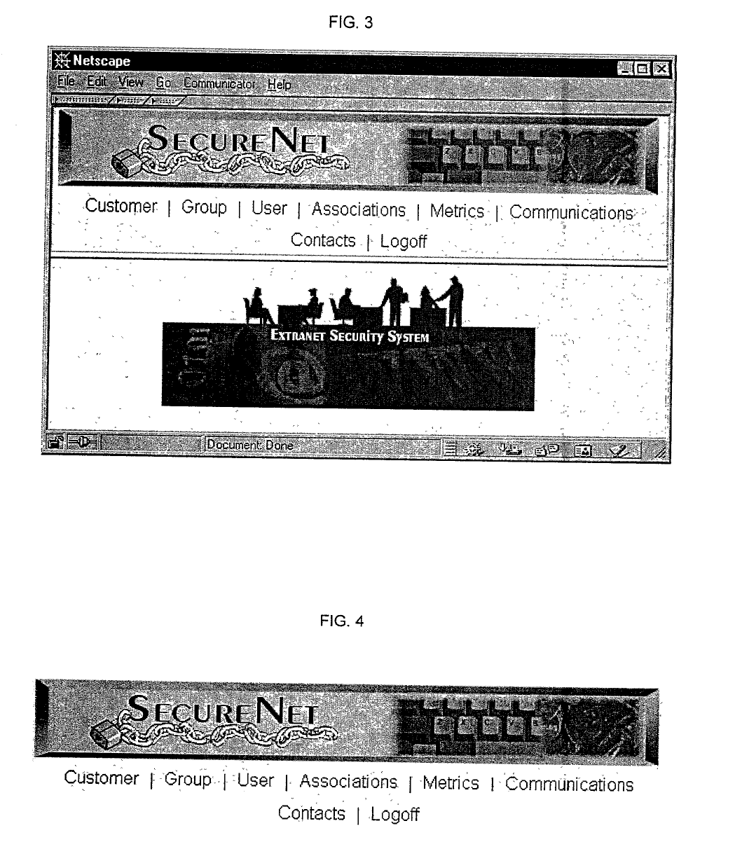

Another example of the method according to the present invention is presented, demonstrating the functionality and benefits resulting from the computer-implemented method of the present invention. Screen shots of this example embodiment are illustrated in FIGS. 3-53.

### Getting Started

Log In

Once you have received your username and password, you can access SecureNET:

1: Enter the following address into your browser's address or location field: http://chemprod.pitts.bayer.com/servlet/securenet.auth.Login

2: Enter your username and password in the boxes on the PolyChem Intranet Login page.

3: Click Login.

Successfully logging in brings you to the SecureNET homepage, as illustrated in FIG. 3.

Navigation

Use the text links at the top of the page to navigate the various sections within SecureNET, as illustrated in FIG. 4.

Customer

Add new customer bill to information, edit existing customers and modify user profiles.

Group

Add new groups and view and edit existing customer groups.

User

Add new users and view and edit existing internal and external users.

Associations

Associations allow internal users access to only specified BayerONE customer accounts. This limits their ability to impersonate any user on the application.

Metrics

Provides hit reports on what customers are accessing on BayerONE.

Communications

The communications section gives SecureNET users the ability to send messages to the user's online message board or send an e-mail to their personal e-mail inbox.

Contacts

Contacts vary from account to account. This allows for creating specific contact lists for specific accounts.

General Icons & Buttons

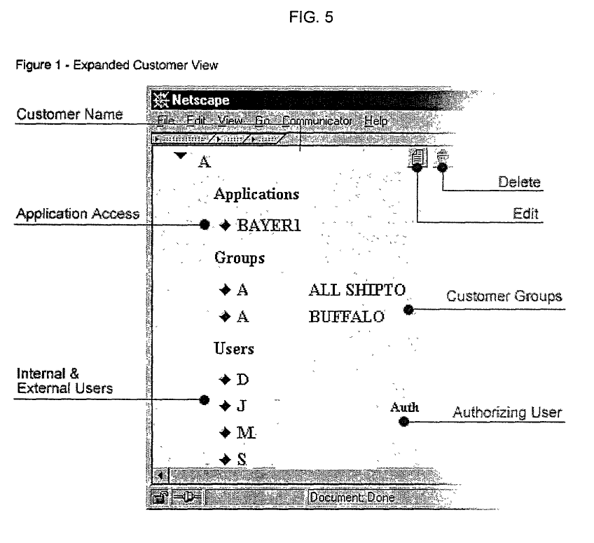

The following icons and buttons, as illustrated in FIG. 5, can be found throughout SecureNET:

Edit

Found to the right of a customer, group or user's name, use to edit information on that particular account.

Expand

Found to the left of all customers, groups and users. Depending on which view you are currently in, will expand that account to show all related information tied to that account.

For example: If you are viewing accounts by customer, clicking on the expand button next to the customer name will show display links to the applications for that customer, the groups associated with that customer and the users assigned to that account.

Delete

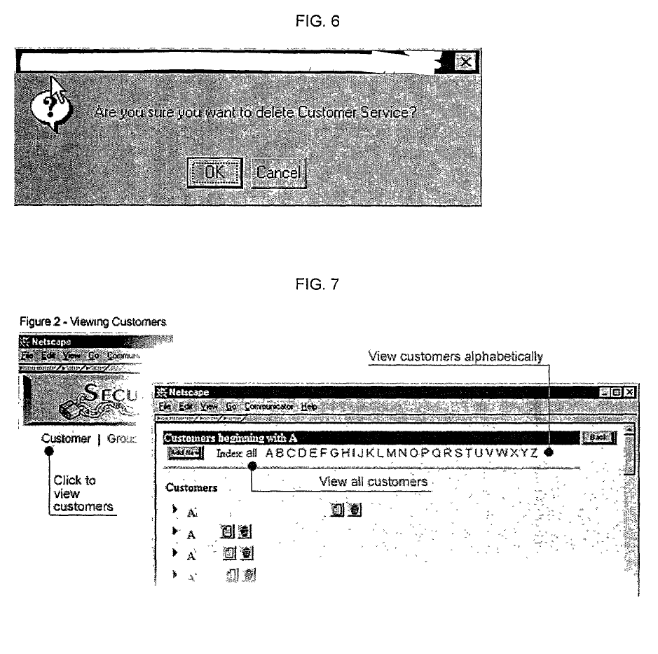

Found to the right of a customer, group or user's name, use to delete information from SecureNET. A pop up message, as illustrated in FIG. 6, will appear before deleting. Clicking OK will delete the customer, user or group.

NOTE: When deleting a customer, you will delete all information (including groups and users) tied to that account.

Auth—Authorizing users will have a red Auth tag appearing next to their name.

The Calendar Object

The Calendar Object, used in both SecureNET and used on the BayerONE website, provides a visual way to enter dates into the system.

Pictured below is the calendar object.

>>Keeps the Month and goes forward one year

<<Keeps the Month and goes back one year

>Next month

<Previous month

Clicking on the numeric value representing the date will close the window object and place the date selected in the field next to the calendar object you clicked.

### Customers

Adding accounts to BayerONE starts with adding customers to SecureNET. The customer section of the application selects billto location information for a customer account. This billto information is then tied to shiptos through adding groups and then order, product and account history information may be accessed online.

Viewing Customers

As illustrated in FIG. 7, clicking on the Customer text link at the top of the SecureNET page will display customers who have been set up on BayerONE.

Customers beginning with “A” are initially displayed. You may view all customers currently set up by clicking on the “all” link or choose to view customers alphabetically.

Click on the Edit icon next to the customer name for detailed information on that customer.

Add a New Customer

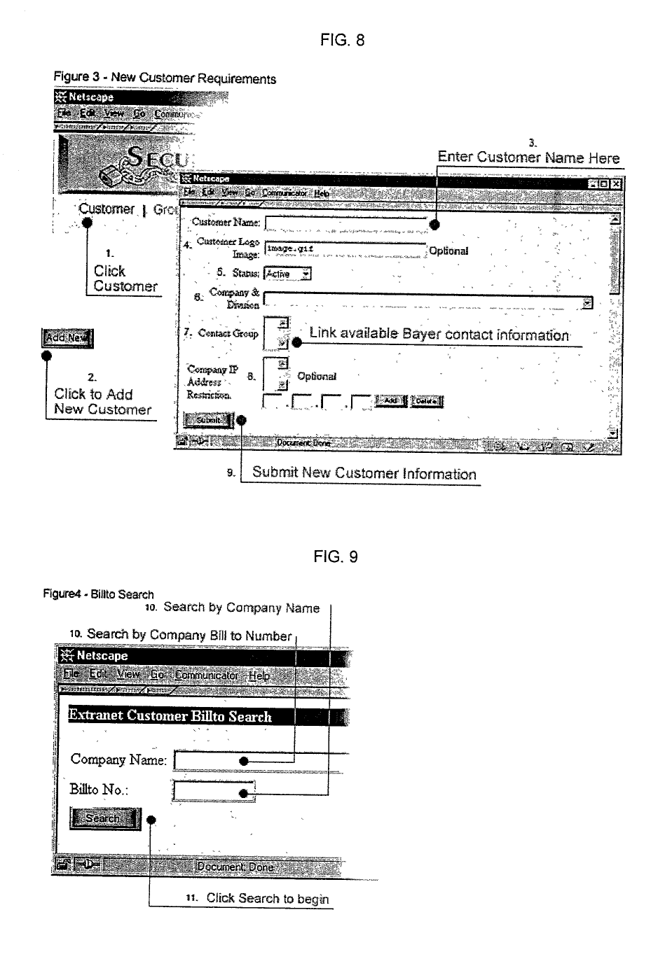

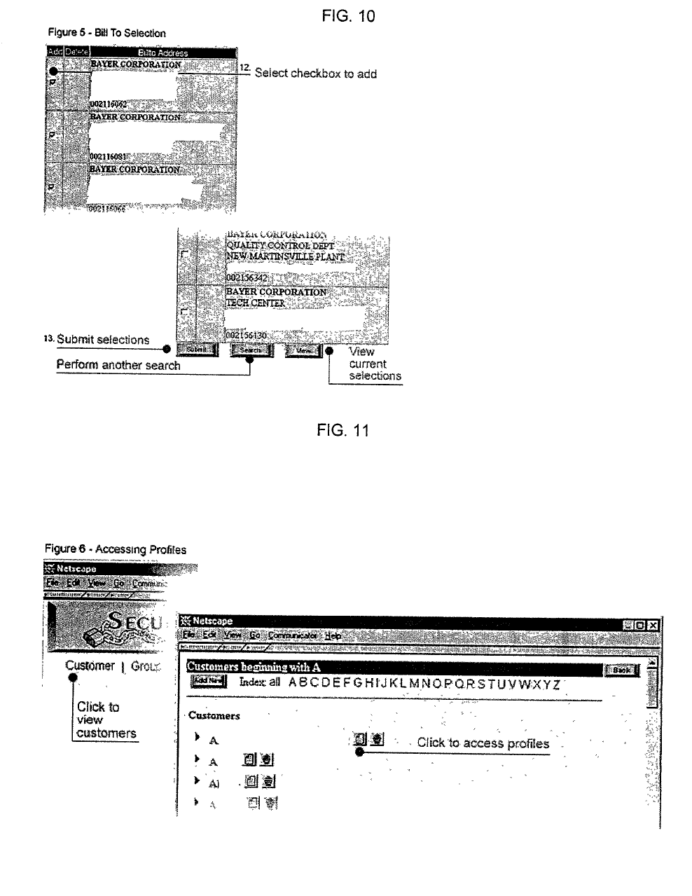

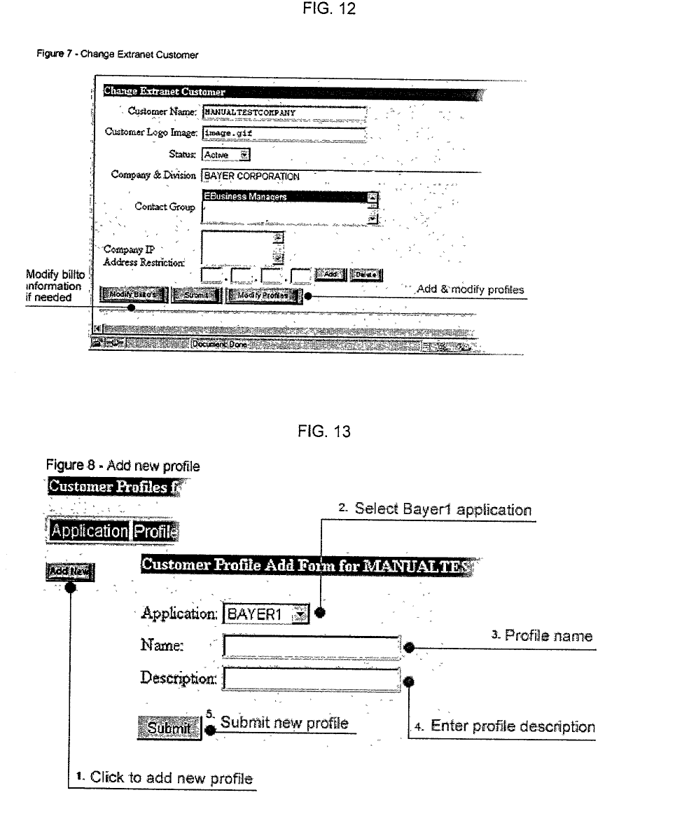

Follow these steps to add a new customer account to SecureNET, as illustrated in FIG. 8:

1. Click “Customer”

2. Click “Add New” button

3. Enter Customer Name

4. (Customer Image is not required)—Optional

5. Select Status—Active or Inactive

6. Select the Bayer division for the customer account

7. Choose from available Contact Groups—use the Ctrl key to add multiple groups

8. Enter IP Address Restrictions if available—Optional

9. Click Submit

NOTE: Once the Company & Division are selected, the available contact groups that have been created for that group will appear in the Contact Group box.

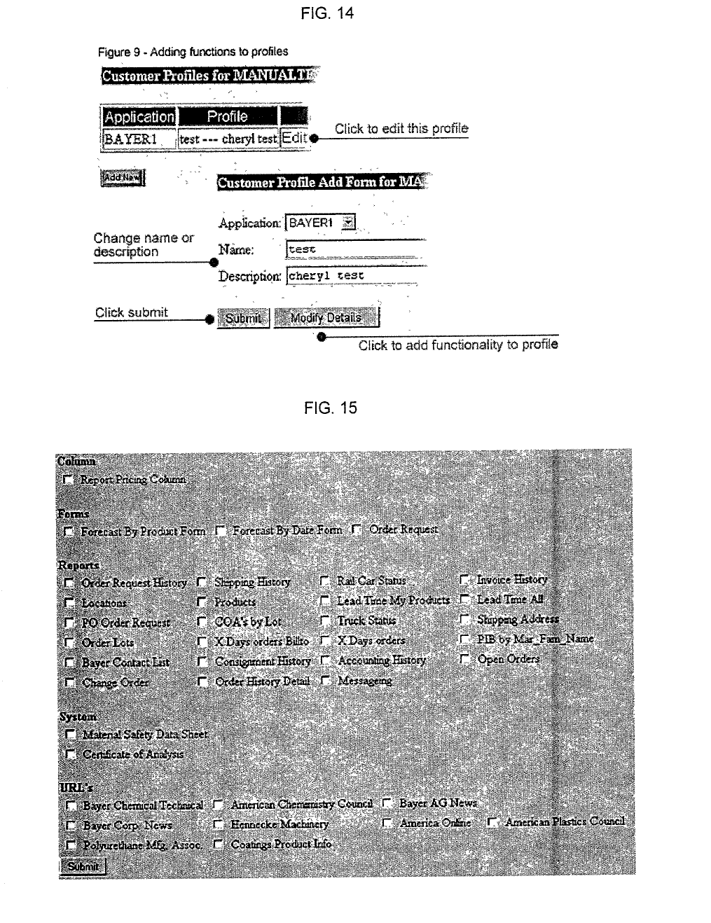

Once you click Submit, you are brought to a customer billto search page, as illustrated in FIG. 9. Enter a full or partial customer name OR enter a 6 digit bill to number (do not include location number).

10. Enter Company Name OR bill to number

11. Click Search

The application will retrieve all company billto information matching your search requirements, as illustrated in FIG. 10.

12. Select the checkbox next to all billto addresses you would like to add.

13. Click Submit

Once submitted, the page will refresh to show the billtos you have selected.

NOTE: Bill to information NOT selected will appear in beige.

Selected billtos will appear in blue/green.

Select the checkbox next to any billto you wish to remove from the list that was selected in error.

Click submit again once the checkbox is selected to refresh your selections.

You may now add groups to this customer account to associate shipto location information to the billtos selected here.

Edit Existing Customers

Return to the Customer page by clicking on customer from the main menu.

Click the Edit icon next to the customer name, as illustrated in FIG. 11, to open up the “Change Extranet Customer” page.

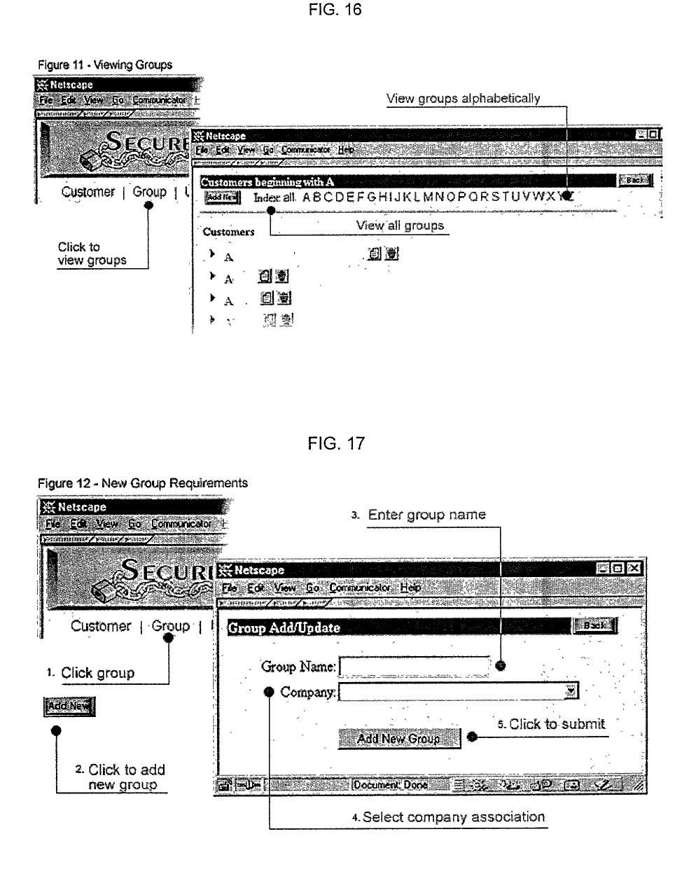

The Change Extranet Customer page, illustrated in FIG. 12, allows you to add to or modify any information you may have entered about a customer. You may:

| | |
|---|---|
| Change the customer's name | Link additional contact groups |
| Update logo information | Assign company IP address restrictions |
| Change status | Modify billtos |
| Reassign Company and Division | Add and modify profiles |

NOTE: Once you have made the necessary changes on this page, click SUBMIT before moving on to modify billtos or modifying profiles. If you do not click SUBMIT, any changes will not be reflected on the account.

Add & Modify Profiles

Profiles are used to limit what a customer can have access to on their BayerONE desktop. Each customer can have multiple profiles depending upon the variety of users they may have accessing the website.

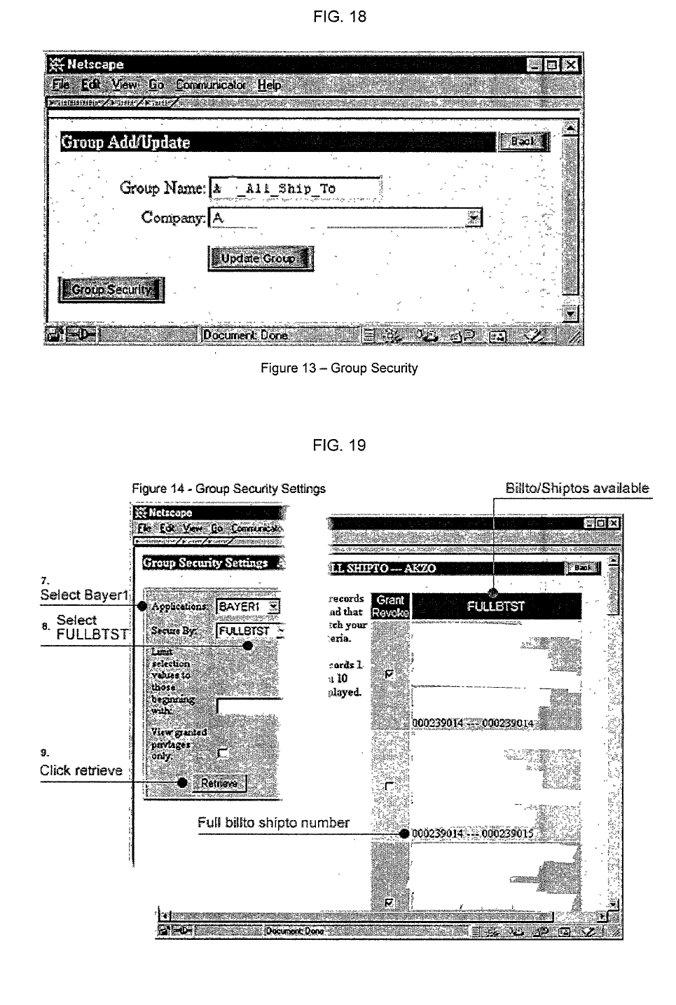

If you are creating a NEW customer, a profile will not exist for that customer until you create one. Profiles exist per customer so one must be created for each account. After clicking the modify profiles button, you are taken to a screen illustrated in FIG. 13. Follow these steps to add a new profile to a customer:

1. Click the “Add New” button

2. Ensure BayerONE is selected from the applications drop down list

3. Enter a name for the profile (ex: purchasing)

4. Enter a description for this profile (ex: all reports plus order requests)

5. Click Submit

When you have submitted a new profile, the page will refresh and you will see the new profile you have added. The profile currently does not establish any functionality on the user's desktop.

6. Click Edit to add functionality to the profile or make changes to the name and description, as illustrated in FIG. 14.

If you make changes to the name and description, make changes then click Submit

If you would like to make changes to the profile functionality, click Modify Details

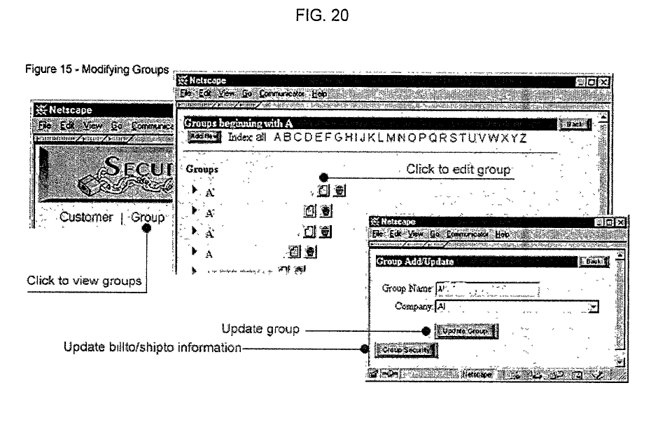

FIG. 15 illustrates the Profile Functionality Selection Page.

7. Select each checkbox corresponding to the functionality you wish to add.

8. After all desired boxes are selected, click Submit.

NOTE: The page will refresh to accept your selections. After doing so, an Exp will appear after the Report Pricing Column if it was selected. Click there and you will be able to select which billto/shipto locations will not view pricing.

NOTE: From time to time, you will notice updates to this page when new functionality is added to BayerONE. Additionally, some checkboxes do not add anything to a user's desktop.

### Groups

A customer account on BayerONE can have just one or multiple groups. Regions may divide customers (east, west, south . . . ). or they may be divided by the levels of access users who may be allowed to view online. Whatever the reason, creating groups within SecureNET ties together the billto and shipto location information that will be displayed for a user online.

Viewing Groups

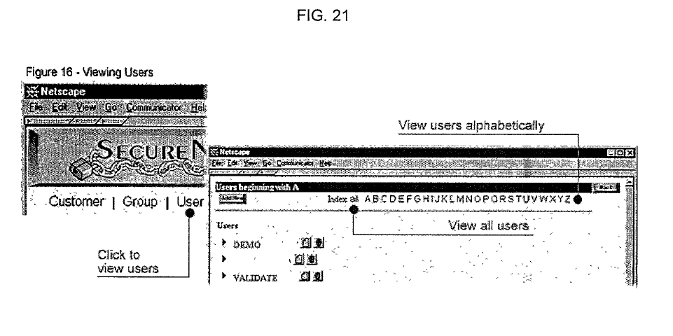

Clicking on the Group text link at the top of the SecureNET page will display groups that have been set up for particular customer accounts, as illustrated in FIG. 16.

Groups beginning with “A” are initially displayed. You may view all groups currently set up by clicking on the “all” link or choose to view groups alphabetically.

Click on the Edit icon next to the group name for detailed information on that group.

Add a New Group

Follow these steps to add a new group to SecureNET (FIG. 17):

1. Click “Group”

2. Click “Add New” button

3. Enter Group Name

4. Select Company from drop down list

5. Click Add New Group

Once the Add New Group button is clicked, the page will refresh and the Group Security button will appear, as illustrated in FIG. 18.

6. Click on Group Security, which brings you to the screen illustrated in FIG. 19.

7. Select BayerONE from the applications drop down list

8. Select FullBTST

9. Click Retrieve

10. Check those combinations you wish to add to the group

11. Click Save at the bottom of each page when adding billto shipto information

Selected Billto Shiptos will appear in blue/green. Those that are not selected will appear in beige. If a billto/shipto combination is not appearing in the list, please verify that the combination is valid. The full billto shipto number appears below every address. The combinations are retrieved in order by their billto number.

NOTE: When clicking save, the combinations you add to the group will refresh and you may proceed to additional or previous pages using the next 10 and previous 10 buttons at the bottom of every list.

Users may now be assigned to this group to start accessing account information.

Edit Existing Groups

Return to the Group page by clicking on Group from the main menu. Click the Edit icon next to the group name to open up the “Group Add/Update” page.

The Group Add/Update page allows you to add to or modify any information you may have entered about a group. You may:

Change the group name

Reassign the group's company association

Modify billto/shipto combinations associated with the group

Once you have made the necessary changes on this page, as illustrated in FIG. 20, click Update Group before moving on to update billto/shipto combinations (accessed through Group Security).

### Users

A customer account is ready for online access once a customer and group are created for the account. All that is needed now are the users. Without users, the account may not be accessed by internal or external users/customers. SecureNET allows internal users to be added to a customer account so that a sales rep, customer service rep or any other internal user may assist their customer with their use of BayerONE. Whether they are internal or external users, viewing, adding and modifying users is relatively the same.

Viewing Users

Clicking on the User text link at the top of SecureNET page, illustrated in FIG. 21, will display internal and external users that have been set up on BayerONE.

Users with last names beginning with “A” are initially displayed. You may view all users currently set up by clicking on the “all” link or choose to view users alphabetically.

Click on the Edit icon next to the user's name for detailed information on that user.

NOTE: Both internal and external/customer users are listed together. You can determine whether they are internal or external by opening the particular account.

Add a New User

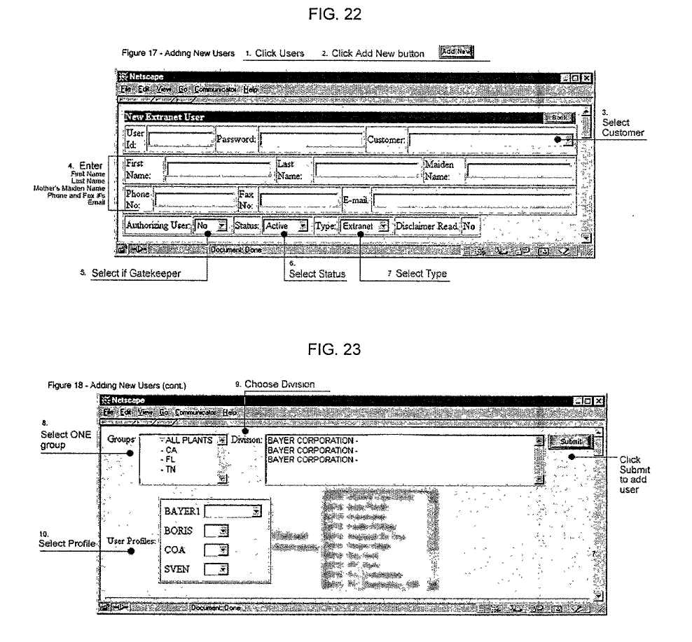

Follow these steps to add a new user to SecureNET (all fields on the user form MUST be completed to add a new user to BayerONE)(FIG. 22):

1. Click “User”

2. Click “Add New” button

3. Select Customer the user belongs to from the drop down list

NOTE: The bottom half of the screen will appear blank until a customer is selected.

4. Enter:

First Name

Last Name

Mother's Maiden Name

Phone and Fax numbers

E-mail

5. Select if authorizing user (YES or NO)

6. Select Status (Active or Inactive)

7. Select Type

Extranet—use for customer access. Secures access to just the customer account selected.

Intranet—use for all internal users (customer service reps, sales reps . . . ). In conjunction with the Customer Association section in the bottom half of the page, allows internal users the ability to masquerade their customers.

The bottom half of the page, as illustrated in FIG. 23, will display the groups and profiles you have created for the account.

NOTE: A user cannot be added to a customer unless at least ONE group and ONE profile have been created for that specific customer account.

8. Choose ONE group

9. Select Division

10. Choose user Profile from BayerONE drop down list

11. Click Submit to add new user

NOTE: When adding a new external/customer user, you do not need to fill in the customer association section in the bottom half of the page.

For Internal Users, the Customer Associations section, maintained in the Associations section of SecureNET (see Lesson 4 on creating and maintaining customer associations) allows for limited customer masquerading ability.

NOTE: Once a new user is submitted, SecureNET will return you to the initial “A” listing of users.

Edit Existing Users

Return to the User page by clicking on User from the main menu. Click the Edit icon next to the user name to open up the “Change Extranet User” page.

The “Change Extranet User” page allows you to add to or modify just about any information you may have entered about a user. You may:

Change/Review password information

Reassign the user's company association

Modify/Update:

First Name

Last Name

Mother's Maiden Name

Phone and Fax numbers

E-mail address

Authorizing user status

Account status

User type (internal/external)

Group, Division or Customer Association

Profile selection

Once you have made the necessary changes on this page, click Submit. While you may make modifications to any entry in the user form, you may not leave any entry blank. If all information is not available when you click submit, the user's information will not be changed.

New User E-Mail Notification

The following must exist for a user to receive the welcome message for their BayerONE account:

All fields correctly entered in the new user form

Account Status marked ACTIVE

Correct e-mail address

The e-mail will automatically be sent to the new user once the submit button is clicked. E-mails are sent from the Chemicals BayerONE mailbox. This mailbox should be available on your Notes Workspace. Should a welcome message fail, its undeliverable message will appear here. Additionally, should a user choose to respond to the new e-mail message, their response will be delivered to this mailbox's inbox.

### Associations

BayerONE and SecureNET have been designed to allow internal users to view the online accounts of those customers they work with on a daily basis. Associations are not a necessary element in establishing new external customers and users, but they do play an important role for internal users and the information they view at www.bakyerone.com.

Every internal user that is set up for access to account information via BayerONE will have the ability to masquerade external users at all customer accounts. However, developing associations within SecureNET will allow you to limit the data a user views.

Adding Customer Associations

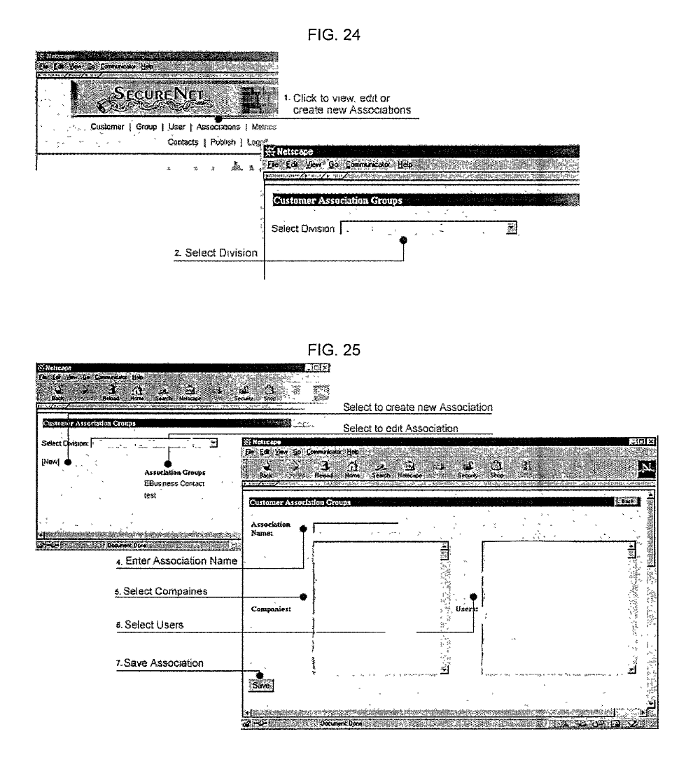

Follow these steps to add a new association to SecureNET, as illustrated in FIGS. 24 and 25:

1. Clicking on the Associations link at the top of SecureNET page will open a selection listbox of all divisions

2. Select a division from the dropdown listbox. Once a division is selected, a list of any currently existing groups will appear under the header Association Groups.

3. Click on the [New] link and the page and the Customer Association Groups will open.

4. Enter in a name for the Associations in the Association Name field.

5. Select a company or companies from the multi-list select box. To select more than one item, press the CTRL button on the keyboard while clicking the company name.

6. Select a user or users from the multi-list select box. Again, more than one user may be added to the association by holding down the CTRL button when clicking the user's name.

7. To save the association, click the save button in the bottom left corner of the page.

Viewing Associations

Viewing Associations can be done from two places. One place is by looking directly at the Associations. Go to the Associations page by clicking on the Associations link on the main menu, choose a division, and click on the name of the Association you wish to edit. You can view the association from this page.

If there is a question as to a user's Association, go to the user's page, click on the edit button and in the bottom section is a list of associations. If an Association is assigned to that user, the association will be selected in blue. Associations can be added, changed or removed from the user pages as well.

Modifying Associations

Return to the Associations page by clicking on Associations link on the main menu. Choose a Division, and click on the name of the Association you wish to edit. This is a link and will open up a page with the current association.

The “Customer Association Groups” page allows you to modify:

Customers

Users

Association Name. Changing the Association Name will not delete the current association. It will create a new association

Hold down the CTRL button if you only wish to add or remove the item (customer or user) in the list. Please note: by not holding down the CTRL button and clicking an item in the list will unselect all items in that list.

### Metrics

SecureNET allows you the ability to generate reports that show the amount of online activity that BayerONE has received. This report may be analyzed and limited by company, division, day, month, year and/or activity type. The reports will show the number of hits the BayerONE's website has received from external users.

1. Click on the Metrics link in the main menu of SecureNET. See FIG. 26.

2. Next you are asked to choose a division. The choice ‘All’ will display the reports with results from all divisions, sorted by that division.

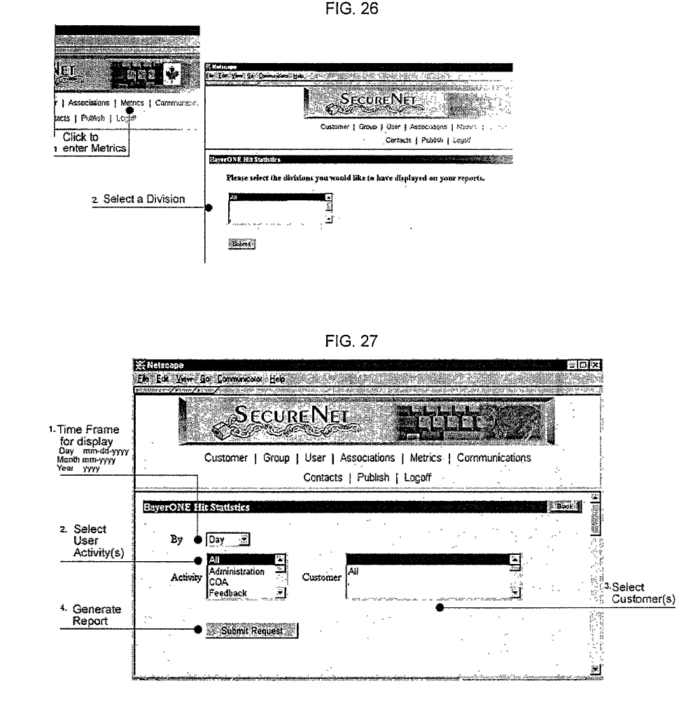

3. Clicking the Submit button will bring up the next screen, FIG. 27 is an example. This screen asks you to further define your search.

4. The BayerONE Hit Statistics pages first ask you if you wish to refine your search. The following choices are available:

i. By: indicates the data can be combined on for a company on a daily basis, day (date 3/26/2001) monthly basis, month (2001-03), or yearly basis, year (2000, 2001 etc).

ii. Activity: This allows you to limit the report by certain pages within the BayerONE application. More than one Activity may be selected by holding down the CTRL key and clicking on the activities in the multi-select listbox. The ‘All’ value, which is selected as the default, will show a report on all activities in the list.

iii. Customer: This is a list of all the customers. If a division was chosen, this list will only include customers for that division. The ‘All’ selection for division, will provide a report containing all customers, unless you choose to limit the customers. If you wish to limit the customers displayed, click on the customer for whom you want a report generated. Again, the Customer select area is a multi-list selection, so more than one customer may be selected by holding down the CTRL button and clicking the customers in the list. By leaving the blank area selected, you are choosing to view all customers.

iv. Once you are satisfied with your selections, click on the Submit Request button, and the report you requested will be generated.

Some of the available fields are as follows:

1. Date: gives the date the activity occurred.

2. Customer: lists the name of the company that preformed the activity.

3. Activity: is the activity type. The list of activity types on the search page for the Metrics gives a list of all the activities.

4. Description: gives the exact page they viewed. For example the Activity type is Reporting and the Description may be 15 day Order History, the specific report's name.

5. No. of hits: The number of hits that particular Activity and Description received that day, month or week for that customer.

### Communications

SecureNET provides the ability to send messages to registered users of the BayerONE website, without the hassle of looking up the e-mail addresses for each individual user.

SecureNET also provides a very powerful messaging tool, which allows you to send messages to the Message Board of BayerONE users. The messaging tool permits you to go back and edit a message, change the end and delivery dates for a message, view which users have read your message on the Message Board and edit the recipients of the message.

To get to the Communications section of SecureNET, click on the Communications link in the Main menu for SecureNET.

Send a Message

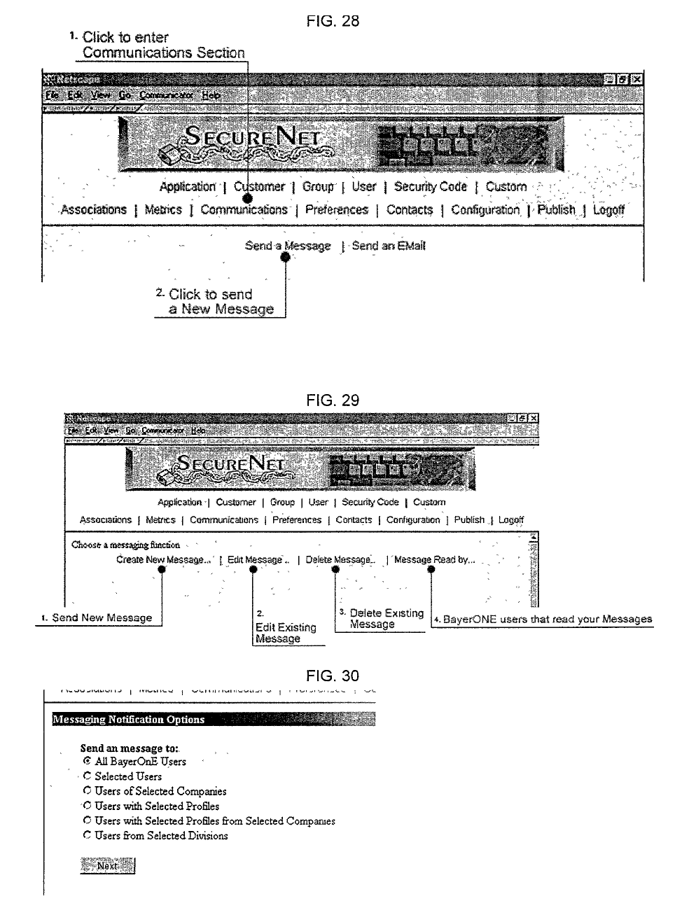

Once you enter the Communications section, as illustrated in FIG. 28, a page is presented giving the options of Sending a Message or Sending an e-mail. See FIG. 29. The section Sending a Message, includes all messaging functions, including editing existing messages and viewing users that have read their Message Board messages you have sent.

Clicking on Send a Message, opens the main messaging menu page, where all your messaging options are listed.

1. Create New Message . . . Allows you to send a new message via the Message Board to any or all BayerONE users.

2. Edit Message . . . Will provide a list of all existing messages in the system that you have sent. You have the option of changing the users who receive the message, the date of broadcast, date of expiration, and the actual message itself.

3. Delete Message . . . Allows you to delete any message that is currently on the BayerONE Message Board or any message that has not been broadcast to the Message Board.

4. Message Read by . . . Tells whether the user(s) the message was sent to have read the message.

To create a new Message click on the Create New Message . . . link. A choice to help limit the users list is provided. See FIG. 30.

All BayerONE Users automatically select all registered BayerONE users.

Selected Users will provide a list of all users from all companies.

Users of Selected Companies first provides a list of all companies, and once a company(ies) are selected, a list of the users from those companies is given.

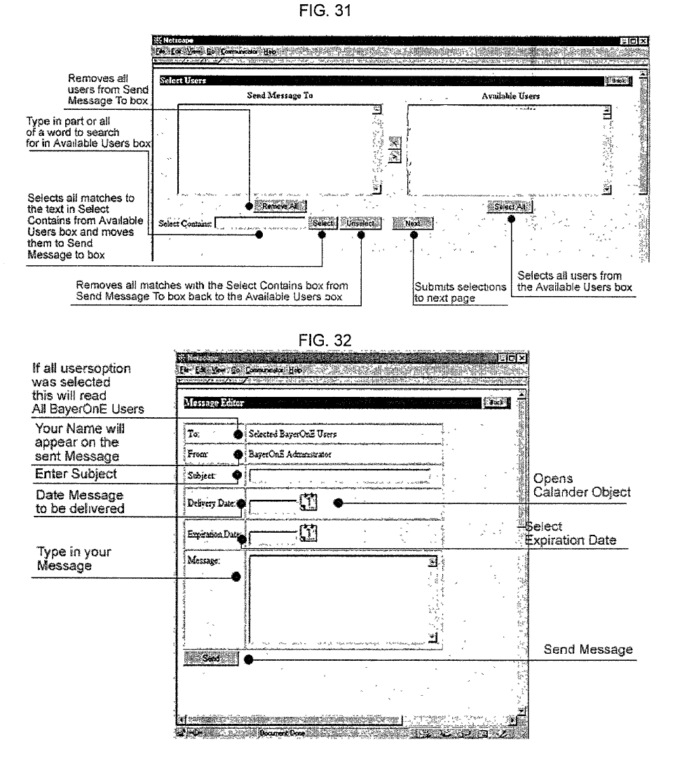

Users with Selected Profiles provides a list of all users with their profiles. A search feature is provided. See FIG. 31 for an example.

Users with Selected Profiles from Selected Companies This is a two-step process. First a list of all companies is provided. Select the company(ies) and click the Next button. Then a list of all users from the selected companies is presented, along with their profiles. (Examples: Purchasing profile, Dock Worker profile, Receiving profile). A search feature is provided. See FIG. 31 for an example.

Users from Selected Divisions: A list of all the divisions is displayed and, once submitted, all the users who have companies associated with that division will be given.

Once you have selected how, if at all, you wish to limit your user's list, click on the Next button.

The first option, All BayerONE users, will take you directly to the page illustrated in FIG. 32, where the message can be entered. All other selections will require you to make selections, to ultimately generate the list of message recipients.

When the message is being sent, a list of the users the message is being sent to will be displayed.

When the message is created successfully, a message will appear stating Message Created, informing you the message was created and saved successfully. Under that message, the messaging menu will be available.

Send an E-Mail

The following will instruct you on sending an e-mail using SecureNET.

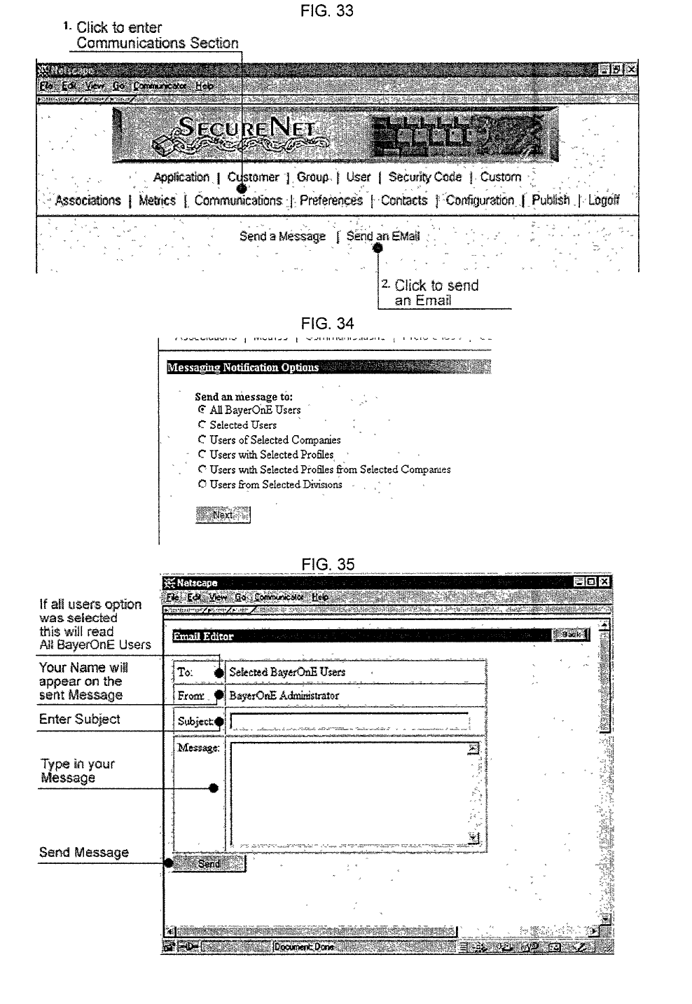

1. Click on the Communications button, in the top header, as seen in FIG. 33.

2. Click the link Send an E-mail.

3. Choose a Notification Option to help limit the users list is provided. See FIG. 34

All BayerONE Users automatically select all registered BayerONE users.

Selected Users will provide a list of all users from all companies.

Users of Selected Companies first provides a list of all companies, and once a company(ies) are selected, a list of the users from those companies is given.

Users with Selected Profiles provides a list of all users with their profiles. A search feature is provided.

Users with Selected Profiles from Selected Companies This is a two step process. First a list of all companies is provided. Select the company(ies) and click the Next button. Then a list of all users from the selected companies is presented, along with their profiles. (Examples: Purchasing profile, Dock Worker profile, Receiving profile). A search feature is provided.

Users from Selected Divisions: A list of all the divisions is displayed and once submitted, all the users who have companies associated with that division will be given.

4. After users are selected, a page opens, and you can compose your message, as seen in FIG. 35.

5. Once you have completed the E-mail Editor form, clicking the Send button will send the e-mail. When the message is being sent, a list of the users the message is being sent to will be displayed.

6. When the e-mail message has been successfully sent, you will be returned to the main Communications page.

Edit a Message

Editing a Message allows you to view existing messages sent to the BayerONE Message Board, view and change the recipients of a message, edit the message body itself, change the subject of the message and change the delivery date and the expiration date.

To edit a message:

1. Click on the Communications link on the main menu of SecureNET.

2. Click on Send a Message link.

3. Click on the Edit Message link.

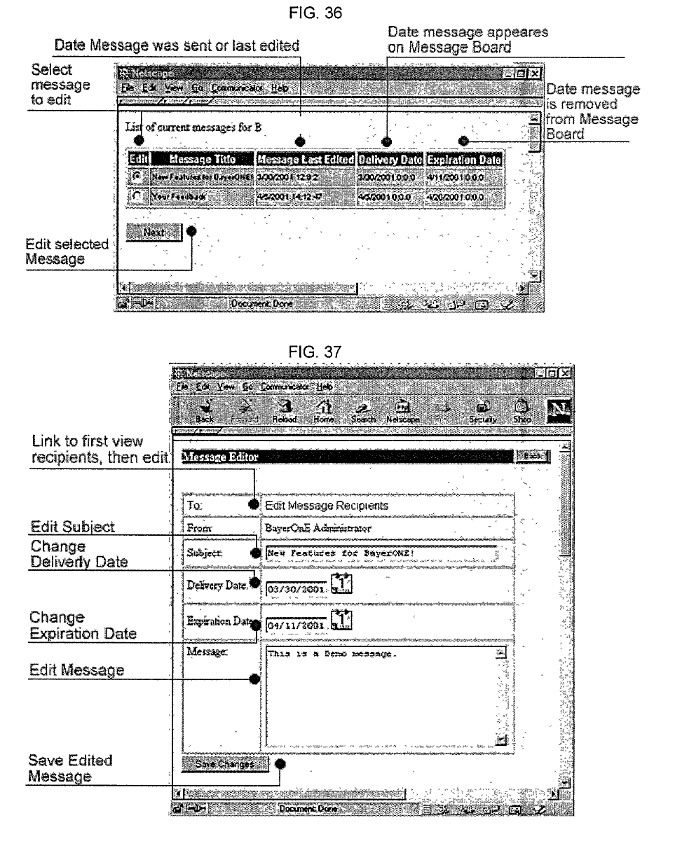

This will open up a page, see FIG. 36, displaying all messages that have been sent by you to BayerONE users via the Message Board. By selecting a radio button under the Edit column. Click on the Next button to edit the message.

4. Once a message has been chosen for edit, click on the Next button. The Message Edit page will appear. See FIG. 37.

5. On the Message Editor Page, the following fields are editable:

Subject

Delivery Date (via the calendar object)

Expiration Date

Message Body

6. The Message Recipients may also be changed as well.

This can be done by either clicking on the To: link or the Edit Message Recipients link.

This will take you to a page where you first view the recipients of the message. Click on the Edit Recipients button.

This will take you to a page with all BayerONE users listed; you may add and/or remove users.

By clicking the Update button, the users are updated and you are returned to the main messaging menu

7. Clicking the Save Changes button will save all changes, except edit user changes, made on the Message Editor form.

View Message Recipients

1. From the Main SecureNET menu, click on the Communications link.

2. Next click on the Send a Message link to take you to the main menu for Messaging.

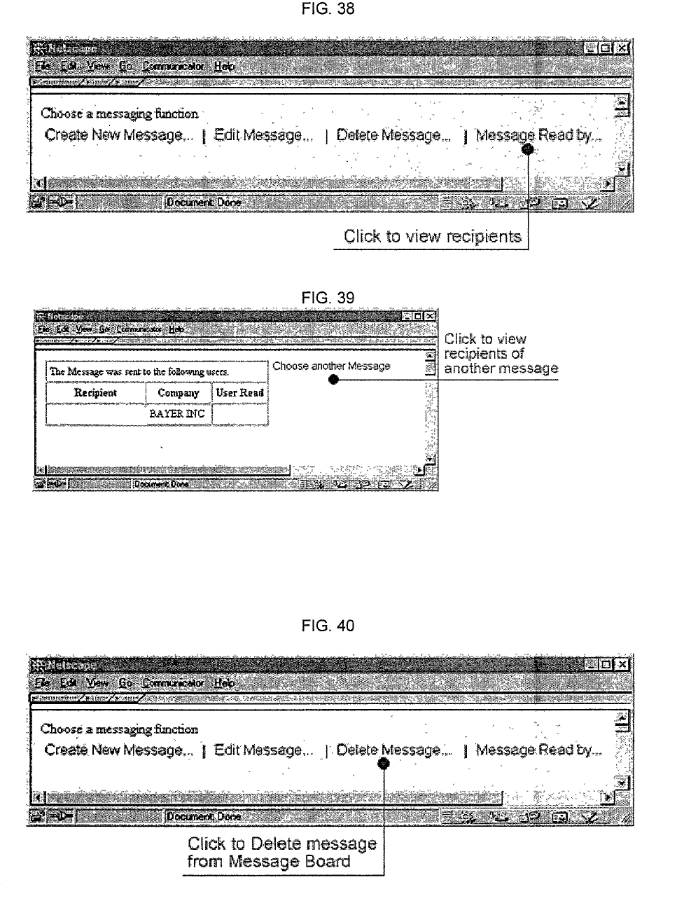

3. Click on the Message Read by link on main menu for Messaging, as illustrated in FIG. 38.

4. This takes you to a list of all messages you have sent that have yet to expire. Click on the radio button of the button you wish to view then the click Next button. See FIG. 39.

5. A table will appear listing all users. The User Read column indicates with a ‘Y’ for yes and an ‘N’ for no. Yes, the user has read the message or no, they have not.

Delete a Message

1. From the Main SecureNET menu, click on the Communications link.

2. Next click on the Delete Message link to take you to the main menu for Messaging.

3. Click on the Delete Message link on the main menu for Messaging, as illustrated in FIG. 40.

4. Displayed next is a page with all messages that have not yet expired. Click the radio button next to the message you would like to delete, then click the next button.

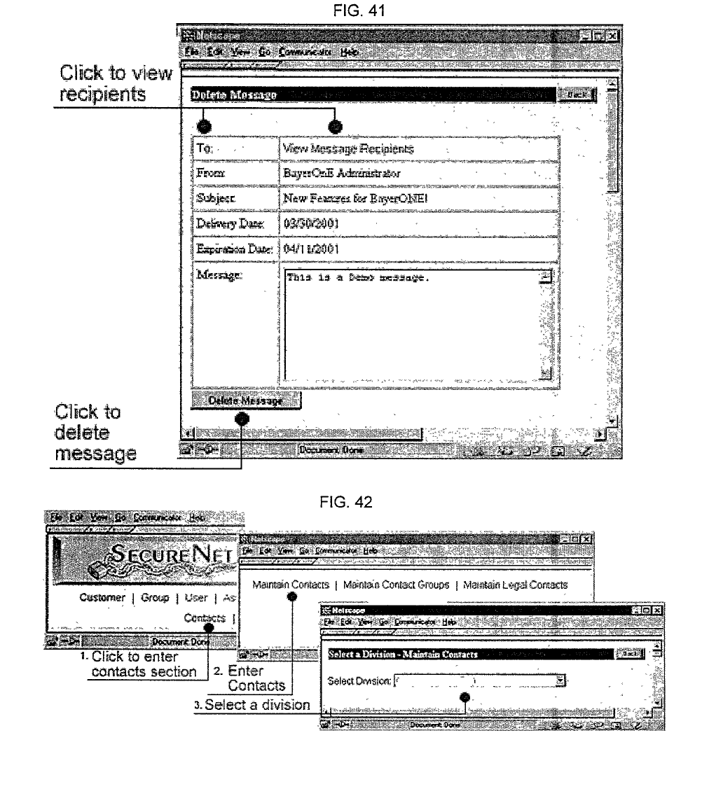

5. The message you wish to delete is displayed. See FIG. 41. From this page you may view the message recipients. Clicking on the Delete Message button will delete the message. Once the message has been successfully deleted, you will be returned to the messaging main menu.

### Contacts

This section, creating contacts and their groups, will populate the report, Bayer Contacts, on the BayerONE website. This report provides a list of contacts that you provide, that your customers may contact in the case of problems or questions. You have complete control over this list. In addition to supplying the customer with a contact name, you can choose to display a Bayer contact's e-mail address, phone number and/or fax number. This can be controlled on a customer-by-customer basis.

Legal Contacts provided a way, on a customer-by-customer basis, to determine who the internal Bayer contact will be on the legal disclaimer. A Bayer legal contact's name and e-mail address will appear on any of the pages presented to the BayerONE authorizing click through user if they choose to not accept the BayerONE Access Agreement. Currently this is in the United States only.

Maintain Contacts

Maintain Contacts is simply a form to enter in Bayer contacts. See FIG. 42.

Follow these steps to add a new contact to SecureNET:

1. From the SecureNET main menu click on the Contacts link.

2. Click on the Maintain Contacts link.

3. Select a division from the drop down list box. All the contacts are organized by division. All contacts regardless of division are available for all groups. This is to keep the list of contacts displayed manageable.

All the contacts that have been created under the selected division are listed in alphabetical order by last name.

From this page you may choose to Create a New Contact, Edit an existing contact or delete a contact See FIG. 43.

Add New Contact

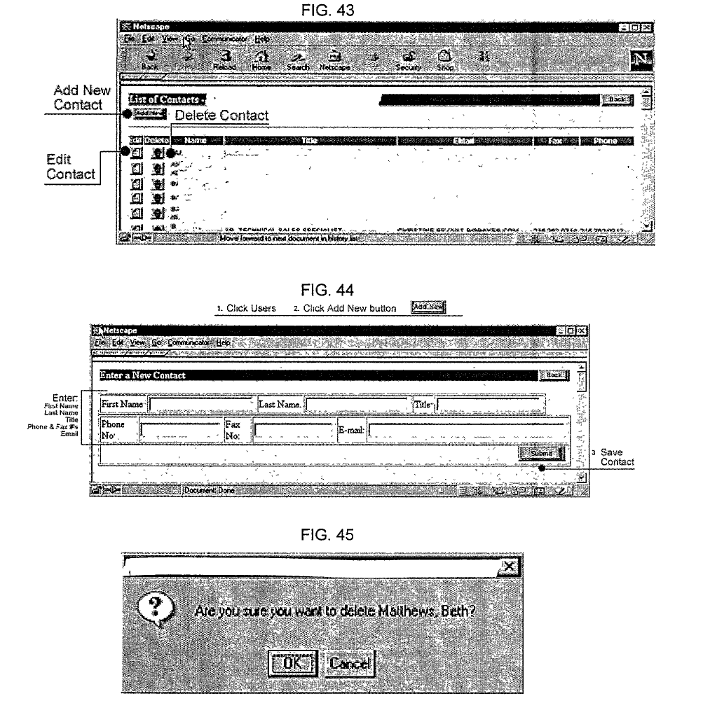

To add a new contact click on the Add New button, as illustrated in FIG. 44.

Enter the following information about the internal contact

First Name

Last Name

Title

Phone Number

Fax Number

E-mail Address

Click the Submit button to save the Contact information

Edit a Contact

From the main menu of SecureNET, click on the Contacts link.

Click on the Maintain Contacts Link

Select a Division from the dropdown listbox

Click on the edit button

Modify/Update the following information

First Name

LastName

Title

Phone Number

Fax Number

E-mail Address

Click the Submit button to save the Contact information

Delete a Contact

From the main menu of SecureNET, click on the Contacts link.

Click on the Maintain Contacts Link

Select a Division from the dropdown listbox

Click on the delete button

A messagebox will appear asking if you are sure you want to delete the user. See FIG. 45.

Click the OK button to delete the user from the Contact list. Clicking the Cancel button does not delete the user.

Maintain Contact Groups

Contact Groups is a named grouping of contacts that may be assigned to one or more customers. Within the group you can choose to display or not display phone numbers, fax numbers and e-mail addresses of the contacts. A group can have one or more contacts.

These are the steps necessary to create a Contact Group.

From the main menu of SecureNET, click on the Contacts link.

Click on the Maintain Contact Groups link.

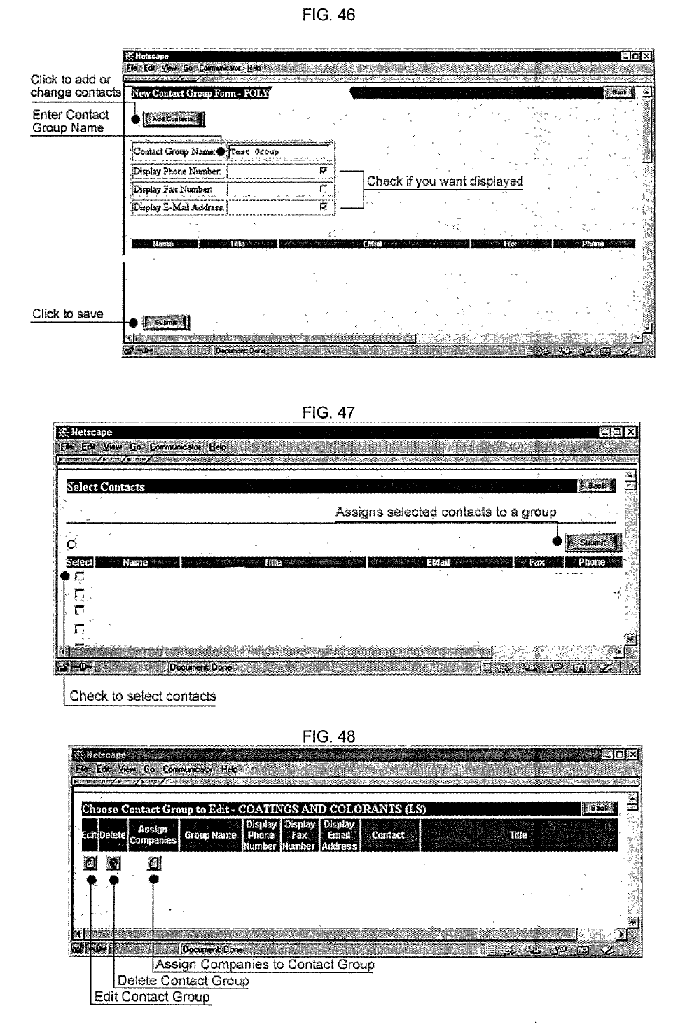

Click on the link, Create New Contact Groups. This brings you to a form where you can add contacts. See FIG. 46.

Enter in the following data:

Contact Group Name, a meaningful name for the grouping of contacts

Insure the checkbox is selected if you wish to display phone number, fax number and/or e-mail address.

Clicking on the Add Contacts button takes you to a page listing of all contacts that have been entered into SecureNET, grouped by division. See FIG. 47. Select the contact(s) you want associated with this group by checking the checkbox on the far left next to their name under the column header Select.

Once you have checked the contacts you wish to add to the group, click on the Submit button located in the far right corner at the top and bottom of the page.

The contacts you selected will be displayed below the checkboxes. If you wish to change the contacts, you may go back by clicking the Add Contacts button.

Once you are satisfied with your selections. Click on the Submit button below the contact list. This button is located in the bottom far left of the page.

Edit an Existing Contact Group

Editing a contact group is almost exactly the same process as creating a new contact group.

From the main menu of SecureNET, click on the Contacts link.

Select a division. For organizational purposes, the Contact Groups are presented based on division.

Click on the Maintain Contact Groups link.

Click on the link, Edit Contact Groups.

A list of all Contact Groups created under the selected division will appear. On the far right are three buttons. See FIG. 48. Edit, Delete and Assign Companies.

Click on the edit button.

This brings you to a form with all the current information about the Contact Group. The information may be edited.

Contact Group Name, a meaningful name for the grouping of contacts.

Changing the checkbox that is selected. If you wish to display phone number, fax number and/or e-mail address.

Clicking on the Add Contacts button takes you to the page listing all contacts that have been entered into SecureNET, grouped by division. The contacts that have been selected will be checked. Select or unselect the checkbox next to the contact(s) name you want associated with this group.

Once you have checked the contacts, click on the Submit button located in the far right corner at the top and bottom of the page.

The contacts you selected will be displayed below the checkboxes for phone fax and e-mail. If you wish to change the contacts again, you may go back by clicking the Add Contacts button.

Once you are satisfied with your selections, click on the Submit button below the contact list. This button is located in the bottom far left of the page. This will save your changes to the Contact Group.

Delete a Contact Group

Deleting a Contact Group removes this group from all companies associated with it. It does not delete the company, nor does it delete any of the contacts from the Contact List.

Below are the steps to delete a Contact Group.

From the main menu of SecureNET, click on the Contacts link.

Select a division. For organizational purposes, the Contact Groups are presented based on division.

Click on the Maintain Contact Groups link.

Click on the link, Edit Contact Groups.

A list of all Contact Groups created under the selected division will appear. On the far right are three buttons. Edit, Delete and Assign Companies

Click on the Delete button.

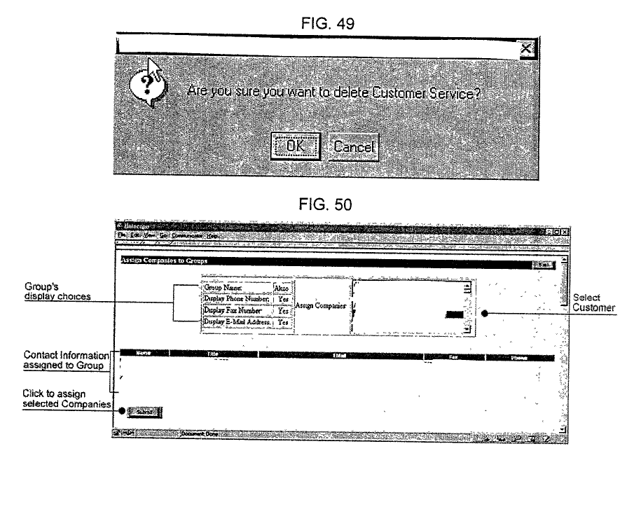

A popup similar to FIG. 49 will appear.

To delete the Contact Group click on the OK button. If the Contact Group is not the one you wish to delete, click the Cancel button and you can exit the transaction.

Assign Companies

For a Contact Group's contacts to appear on the BayerONE website in the Bayer Contact report, a group or collection of groups must be assigned to a Company. One way to assign a group to a Company is through the Assign Companies button in the Contact section of SecureNET. Another way to assign the Contact Groups to a Company is by going to the Company section of SecureNET. Below are the instructions on adding a Contact Group to a Company via the Contact section of SecureNET.

From the main menu of SecureNET, click on the Contacts link.

Select a division. For organizational purposes, the Contact Groups are presented based on division.

Click on the Maintain Contact Groups link.

Click on the link, Edit Contact Groups.

A list of all Contact Groups created under the selected division will appear. On the far right are three buttons. Edit, Delete and Assign Companies

Click on the Edit button under the column header Assign Companies. FIG. 50 is an example of the page that will appear. It displays the Contacts currently assigned to the group, plus the group's display choices (display phone number, display fax number and display e-mail address).

Near the top left side of the page is a multi-list select box displaying all companies. Clicking on a company selects it, and highlights it in blue. To select multiple companies hold down the CTRL button on the keyboard and click the mouse.

To save the selected Companies to the Group, click the Submit button located below the list of Contacts near the bottom left of the page.

Legal Contacts

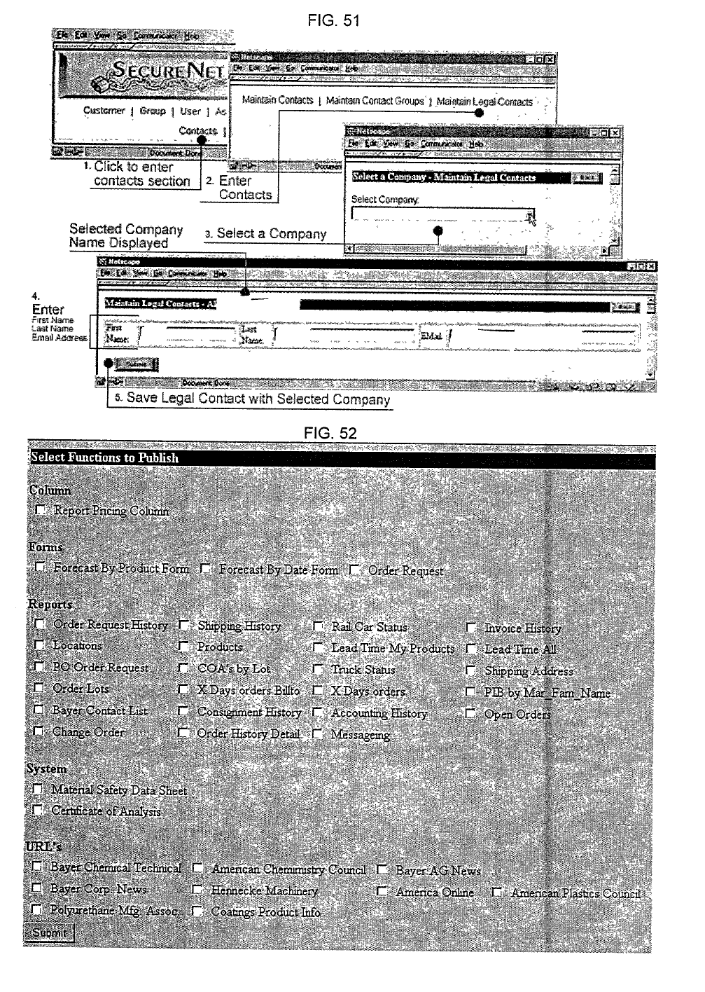

In the United States, for a company's users to have access to the BayerONE application, an authorizing click thru user must agree to the Legal Access Agreement. If the authorizing user chooses not to accept the legal click thru, then they are presented with the name and e-mail address of a Legal Contact. One Legal Contact must be set up per company. This step should be included as part of your process when creating a new customer. Steps to create a Legal Contact for a Company, as illustrated in FIG. 51:

1. From the SecureNET main menu click on the Contacts link.

2. Click on the Maintain Legal Contacts.

3. Select a Company. All companies currently created will be displayed

4. Next a form is displayed to enter in the Legal Contact information. Enter in the following:

Contact First Name

Contact Last Name

The Contact's e-mail address

5. Click on the Submit button to save the Legal Contact with the Company.

### Publish

This section covers adding new features to your customer's website. The features include adding reports, forms, system documents and URL's.

To access the publish feature, click on the Publish link in the SecureNET header.

FIG. 52 is an example of a page where the items available for publishing are available.

Other items that need to be published to appear (or are used) on BayerONE desktops are Columns (currently the only one available is Report Pricing column), Forms, System and URL's.

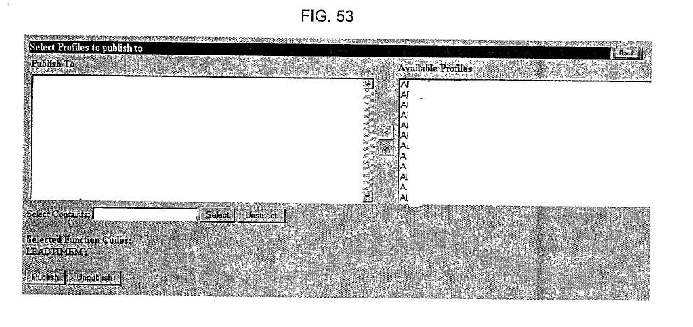

Check an item to publish, then click the Submit button at the bottom. It will take you to a page similar to the one displayed in FIG. 53.

Select from the Available Profiles section the companies you wish to publish to by clicking on the item (CTRL click for multiple items)

The < Button will move over all selected items from the Available Profiles list to the Publish To list.

The > button will move selected items from the Publish To list to the Available Profiles list.

The Select Constraints edit box allows one to enter in a company name, part of a name, a profile type (purchasing, Dock Worker etc). or a division. This feature is case sensitive. Clicking on the Select button will move all items selected from the Available profiles list to the Publish To list. The Unselect button will move all selected items in the Publish to list back to the Available Profiles list.

The Publish button at the bottom will publish the feature whose code is listed under the header, Selected Function Codes. The Unpublish function will unpublish the selected feature.

Publishing and unpublishing features place items to and removes items from BayerONE user's desktops. When this occurs, the user desktops are deleted. What this means is the record for all users that are affected by the change will be deleted from the database. The next time the user logs onto BayerONE, their desktops are recreated and the new item will appear.

### EXAMPLE 3

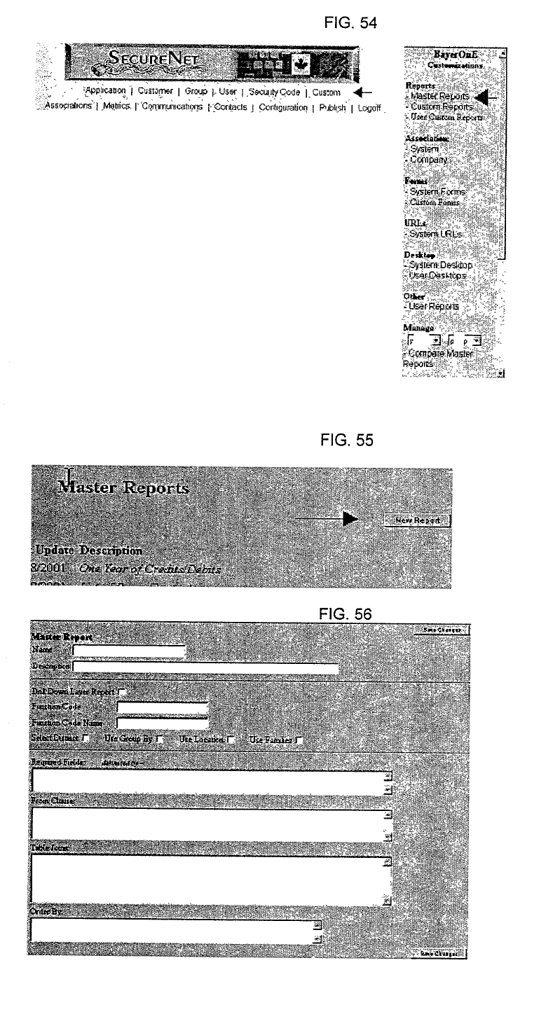

Another example of the method according to the present invention is presented, demonstrating the relationship framework functionality as directed to master and customer reporting and further benefits resulting from the computer-implemented method of the present invention. Screen shots and field charts of this example embodiment are illustrated in FIGS. 54-84.

Create a Master Report

From the SecureNET header click on CUSTOM/BayerONE/Master Reports. See FIG. 54.

Click on the New report button. See FIG. 55. This will take you to the main Master Report configuration page. See FIG. 56. If you wish to edit a report, click on the report name link.

Name and Description: This is the name and description of the Master Report that will be used within SecureNET and is not visible in the BayerONE application. The Master Report name is used as the template report for a Custom Report (discussed and described in detail below). This is also the name shown when publishing function codes to customers.

Drill Down Report: Sets the function code as a drill down report. Will not appear on a desktop and cannot be customized. This report will always be called from another report.

Function Code: The function code is used behind the scenes and determines which reports get published. If a certain Master Report is published, then all Custom Reports using that Master Report get published as well.

Function Code Description: Adds more description to the function code. This is the text that appears when publishing a Master Report to a desktop and also on the customer profile definition page.

Select Distinct: When checked adds a DISTINCT to the SELECT clause.

Group By: When checked, creates a GROUP BY clause using the fields, in the same order, from the SELECT.

Use Location: When checked, the security code is tacked onto the end of the WHERE clause, filtering the results by security. This also tacks on the bill to ship to combinations the user might have selected on their preference page in BayerONE

Example:

AND aa.billto_shipto_compkey in (003804590012097001, 00340890098549001)

When using the security code, the primary table doing the security must be aliased AA in the FROM clause. So in the above example, the billto shipto compkey is located in CHEMSALES.ORDERS_BS

FROM CHEMSALES.ORDERS_BS AA

Use Families: When checked, the report is filtered by the customer's product families. This additional SQL will be tacked onto the end of the WHERE clause. This also tacks on the products the user might have selected to view on their preference page in BayerONE.

Example:

AND (aa.product_family_code =001 OR aa_product_family_code=002)

When using the product family code, the table that contains the column you wish to use the product family code against must be aliased AA in the FROM clause. So in the above example, the product family code is located in CHEMSALES.ORDERS_BS.

FROM CHEMSALES.ORDERS_BS AA

Required Fields: Can be used for any field in the SELECT portion of the SQL statement. All fields in the required field section will be tacked onto the end of the SELECT clause. These fields are not aliased, as the MasterReport fields are aliased when the report is generated. These fields will not be available when creating a custom report and will not be visible to the report when published on the desktop. Required fields must also be included in the Master Report Fields if you wish to display or use them as search fields in the report.

Required fields are used primarily as substitution fields when linking reports. See the section on Link Fields. Even if a field, that will be used as a substitution field, is already included as a Master Report field, and since Master Report fields are aliased when the report is generated in BayerONE (field0, field1, field2) based on their display order, and this order may possibly change, a required field is used. These fields may be aliased, and if aliased, the alias should be used in the substitution field.

From Clause: Where all the table names used in the SQL statement should be entered. FROM keyword should not be used, the reporting module takes care of adding it. The tables in the FROM clause should be comma delimited.

Table Joins: This is the WHERE clause. The keyword WHERE should not be used, the reporting module takes care of it. This section should include all static SQL.

Examples of a valid statement is:

AA.SHIPTO_CUST_LOC=CST.SHIPTO_CUST_LOC

AND AA.ORDER_LINE_TYPE_CODE<=‘02’

AND AA.SHIPPED_STATUS<>‘CANCELLED’

AND AA.ORDER_INV_OPN_IND=‘O’

Order By: The order by appends an ORDER BY clause to the end of the SQL statement. Since fields will be aliased in the reporting module when the report is generated, and users may choose to customize their reports, numbers representing the order of the columns in the SELECT clause are used in the ORDER BY. In the Master Report section there must always at least be a 1 entered in this field. If an ORDER BY is not in the Custom Report this will keep the report on BayerONE from malfunctioning.

When finished with the main Master Report Page, click on the Save Changes button to save all the information just entered. After this is done for the first time, for a particular Master Report, the buttons at the top of the frame change. See FIG. 57.

Save Changes: Saves all changes made on the Master Report main page. Clicking this button will not save any other changes made on any other page, including the Modify Fields and Modify Totals pages. They have their own save buttons.

Modify fields: Takes you to the Master Report Fields page where new fields can be added by clicking on the new field link above the header. Already existing fields may be edited as well. This is done by clicking on the Edit link.

Modify Totals: Directs to the Master Report Totals page

Move to Production: Currently not in use.

Delete: Deletes the Master Report and all Custom Reports associated with it.

Copy Report: Currently not in use.

Transfer Report: Currently not in use.

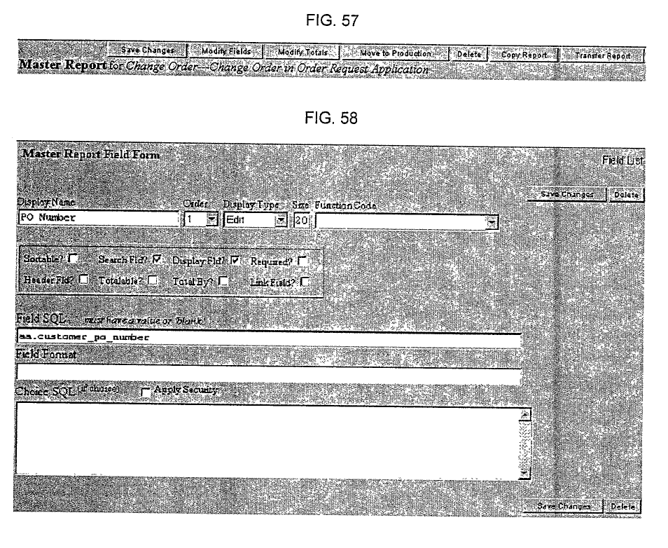

The Master Report field form is illustrated in FIG. 58.

Display Name: The display name is used as the column header within the BayerONE report and will be displayed to BayerONE users as a column header. It is also used to refer to this field in the Custom Report module of SecureNET.

Order: The order in which the columns will appear when creating/editing Custom reports within SecureNET. It gives a starting point for column ordering when creating a Custom report. It is recommended to place display fields first and non-display fields last. The Custom Report will override any order settings when generating the report.

Display Type: Display type is primarily utilized when a field is a Search Field (when the Search Field checkbox is checked in the section below). If the field is not a search field, it must be set to Edit. The display type selected determines the output of the input fields on the search screen for any Custom Report using this particular Master Report in BayerONE. The following is a description of all the options in the dropdown for the display type and how they will behave when generated in the search page of BayerONE.

Edit: An alphanumeric free form edit field.

Check: Not implemented yet.

Choice: Not implemented yet.

Date: Supplies a calendar object for the user to select a full date.

Month: Gives the user a dropdown list of all month year combinations for the past two years. (11-00, 12-00, 01-01, 02-01) are examples of the format presented on the Search Page to the BayerONE user.

Select: Provides a selection list to the user on the Search Page, but also allows the user to edit the field. Places an image to the right of the field which pops up a list of valid values.

Unknown: Any field configured this way will display ERROR for its value and in certain places other messages.

Size: The HTML size of the Display type field on the Search Page of the BayerONE application. <input type=‘edit’ size=25>

Function Code: The only function code valid for this field located in the dropdown are ones preceded by (C). Currently there is only one report pricing (REPORTPRICING). The function codes for columns are defined in the database only and currently there is no other way to define them. When a function code is chosen it restricts, on a line-by-line basis, whether that column is displayed to the user or not. The only example is with pricing, and it restricts based on security. If a customer has an order shipped to them but does not pay for it, another company paid for it and got special pricing, this information should not be displayed. Only the customer who paid for it should see the price, because of pricing issues.

Sortable: If checked, allows the user of BayerONE to sort the report on that column. Two little arrows are shown to the left of the column header in the BayerONE report.

Search Field: Allows a field to be on the report's Search Page and will allow a user of BayerONE to limit the report. A report can have zero, one, or multiple columns as search fields. Making a field a search field in a Master Report allows the field to be a search field in any Custom Reports created from it. Checking this option only makes this field available as a search field. This is setting the field type. The fields display Type determines its format on the search page.

Display Field: If checked, makes a field available for display on any BayerONE report using this Master Report. This can be overridden from the Custom Reporting module

Required: When checked, indicates this field is required for the query, regardless of whether it is displayed on the report or not. If there is a chance a field is needed and that field could be removed from display, either in the Custom Reporting module or if a customer were to customize their report on their desktop and the field may be removed, then check the required field.

Header Field: A field that has header field checked will be used as the report's primary sort, superseding any other sort order set in either the Master or Custom Reporting module. It will be used as a breaking header by the report in BayerONE .

A header field requires the field SQL to be set to ‘blank’.

The SQL added in the Choice SQL section will appear as the text in the header.

On the Modify Report Field page, where all the fields for the Master Report are displayed, any field selected as a header Field will be in bold text.

An example of a Header field is in the Order History Detail report, the Address field, on the next page. In this example, the Ship To Address is used as a header field to split the data up by Ship to address. The address is listed in the header. The SQL to retrieve that text was added to the Choice SQL Section.

Totalable: If checked, will allow this field to be used as a total. This field must be a numeric field in the database. To create a totalable section at the bottom of the report, see the section on Totalable.

Total By: When checked, will allow this field to be totaled for the number of occurrences of data in this field. For example, showing the total dollar amount sold for each product. Please see the section on Totalable.

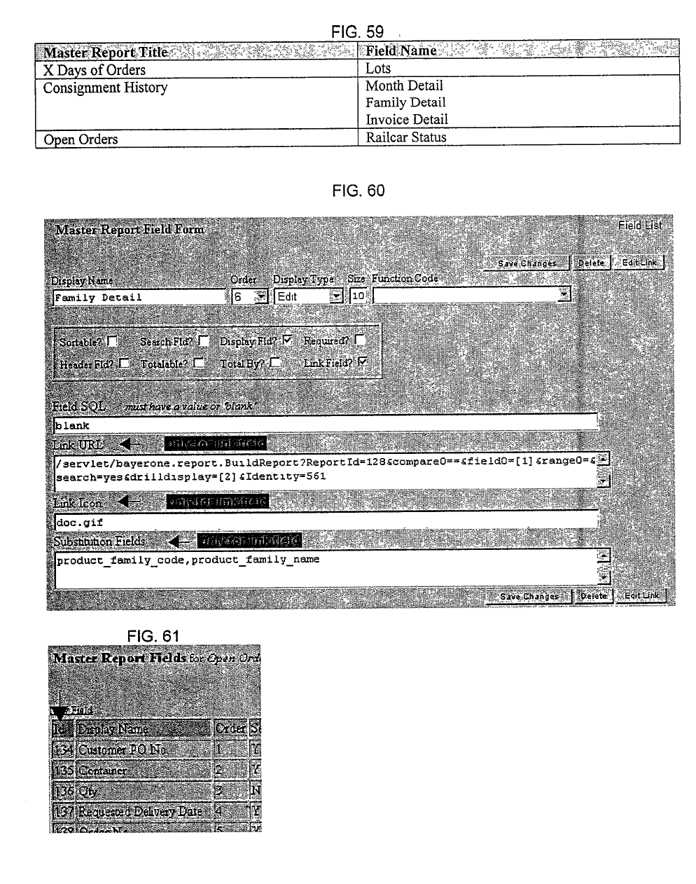

Link Field: Provides a link to another report document or e-mail. No column data is shown, only an icon. When the link field is checked, the Master Report Form Field page changes. Note some of the input fields on this page are different. There are several examples of link fields. Some of them are illustrated in FIG. 59.

Link fields can also retrieve other documents (RetrieveDoc servlet) Currently, for a link field to retrieve a document, there must be specific code added to the RetrieveDoc servlet for those documents. Examples include COA, MSDS and PIB.

Link fields can also be used as links to send e-mail back to Bayer employees. To configure this, the E-mailRepForm servlet must be called and certain arguments are passes. An example is the Master Report Bayer Contact List, Send E-mail column. The arguments are the repE-mail, the e-mail address of the person to receive the e-mail, repFirstName, the first name of the person receiving the e-mail and repLastNam, the last name of the person receiving the e-mail. Please note the Link URL fields are case sensitive.

Example:

/servlet/bayerone.feedback.E-mailRepForm?repE-mail=[1]&repFirstName=[2]&repLastName=[3]The [1], [2] and [3] are referencing the subsitution fields, discussed below.

A Master Report Field Form for Link Fields is illustrated in FIG. 60.

To Make the Link Field Work:

Field SQL should be filled out to be ‘blank’

Doc.gif is the default icon. To use another icon, it must be sized correctly and placed at: /bayerone/images.

Please note the edit link button in the bottom right corner is another way to fill out link fields. It provides a different interface.

Link URL field needs to be filled out. There are several steps necessary to correctly fill out this field. This is the URL used to generate the new report that is being linked with this report. It must be filled out in a way that the BuildReport servlet can interpret the URL and pick off the parameters necessary to generate the report.

First the path to the BuildReport servlet should be entered. Please note this section is case sensitive. It will always be:

/servlet/BayerONE.report.BuildReport?ReportId=report id number

BuildReport is called to bypass the Search page (to get the search page call ExecuteReport). A report number specifies which report to run. Any argument that the report is expecting and that is needed to construct a call, exactly like a call to BuildReport servlet would appear coming from a search page in BayerONE.

report id number is the id number for the custom report that will be the linking report. This number may be obtained by going to the main custom report page and looking at the Attribs the first column on that page (see the Custom Reports picture and look at the column indicated by the number 1 arrow).

If the link field requires parameters to provide limits or arguments to the linking report they must be passed following this pattern exactly.

Each parameter is delimited by a &. A & is not needed at the end of a link field.

The Identity parameter is a numerical comma delimited list of column numbers representing a column that will be used for comparison in the SQL statement of the linked report. Each column created in the Master Report has a column number, and this number must be used in the Identity. To determine the number of the column, go the Master Report Field page of the linked report. A list of all columns in that report is shown. See FIG. 61. The field chosen for an Identity field must have a database column value in the Field SQL section of the Master Report Field Form page and not a blank.

The order of the column numbers listed for the Identity is important if more than one argument is to be passed. The first value in the comma delimited list will be compared with the first set of parameters and its values (compare0, field0 range0) and the second identity value will be compared with the second set of parameters and its values (compare1, field1 range1).

Arguments for the Linking Report

Looking at the Search page for most reports used in the BayerONE application, it has three HTML inputs for each criteria. These inputs make a set that is appended to the URL when the Generate Report button is clicked. A URL is generated using any information entered on that Search page. We are creating that same URL in the Link URL field. These inputs are the same exact parameters in the order they need to be for the Link URL (compare, field and range).

Example: from the Open Orders Report, Master Report Field Form: Lot compare0==&field0=[1]&range0=&compare1==&fleld1=[2]& range1=&customize=N&popup=Y

The above example shows passing two arguments to the link report. Each argument must be passed using a set of parameters that are understood by the Reporting Module in BayerONE. compare#=, field#= range#=. The number (#) is used to make each parameter unique. The first set of parameters must use the number 0, the second set must use the number 1, and the third set the number 2 . . .

If no value is to be sent with a parameter (like range in the above example) do not enter anything, just follow it immediately with the next parameter, leaving no space.

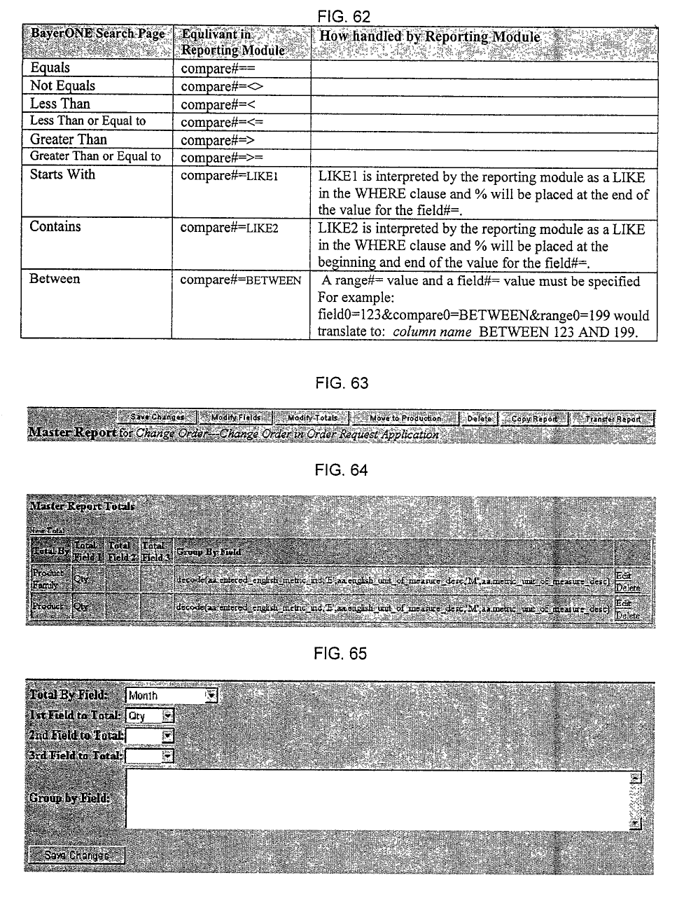

Compare compare=The valid values for compare are shown in FIG. 62.

Field: field= should be the value you want to compare, either hard coded if acceptable field=001 or a substitution field may be used if it is variable based on the row chosen. Substitution fields are listed in the Substitution field section of this page. In the Master Report Field Form picture shown above, there are two substitution fields shown product_family_code and product_family_name. To use the product_family code in the Link URL field place its ‘order number’ in brackets field=[1] or if you wish to use the product family name field=[2] A field in the substitution field area may be used in the Link URL field more than once and can be used out of order (2 can be used before 1). These substitution Fields must appear in the Required Field section of the Master Report Main page and can be aliased on the page. If aliased on in the Required field section, they must also be aliased in the substitution Field for the correct value to be picked up in by the link.

Range: range= This is used only when the compare is Between, like between two dates. Like the field, the value can either be hard coded or come from a substitution field.

If passing parameters that need to be processed by the report include the parameter in the URL add the parameter search=yes.

To not allow customization of a linked report add the customize=N to the Link URL field.

To have the link report pop up in another window, add the parameter popup=Y

To add further description to the title of a linking report, like including the product name or product family displayed, add the parameter drilldisplay=[subsitution field number].

Totalable:

From the Master Report main page, FIG. 63, click on the Totalable link to go to the Modify Totals button at the top of the frame.

Existing totals for the Master Report will be displayed in the top frame. To edit or delete an existing total, click on the Edit or Delete link on the far right side. To create a new total, click on the New Total link near the top left.

If no totals have been defined for this Master Report, only the New Total link will be present as well as the column headers. A Top Frame for Master Report Totals is illustrated in FIG. 64, and a Bottom Frame for Master Report Totals is illustrated in FIG. 65.

To create totals on a Master Report, there must be at least one field each configured to be a Total By field and at least one configured to be Totalable. This is done in the Master Report Field Form and by checking the checkbox for Total By for a non-numeric field (i.e., month, or product) and Totalable for a numeric field (quantity or dollar amount).

If in a particular report, there is more than one Total By or Totalable field created, they all will appear in the dropdowns. The ft Field to Total: is a dropdown field. When a value is selected, it will be summed up using SQL in the reporting module on BayerONE. The Total By Field will be added to the SQL statement in both the SELECT and in a GROUP BY. The items in the SQL statement will be ORDER By the Total By Field.

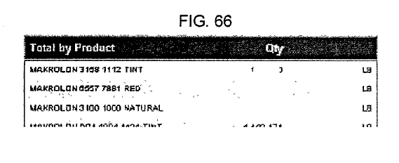

The Group By Field, is used when you wish to add another column to the total field that is not going to be summed up. It will add another column to both the SELECT statement and the GROUP BY statement that is constructed by the Reporting Module within BayerONE. An example of a Group By field would be a unit of measure. Any column added in the Group By Field must use the same aliases for the tables as the Master Report. A Total Example is illustrated in FIG. 66.

Create a Custom Report

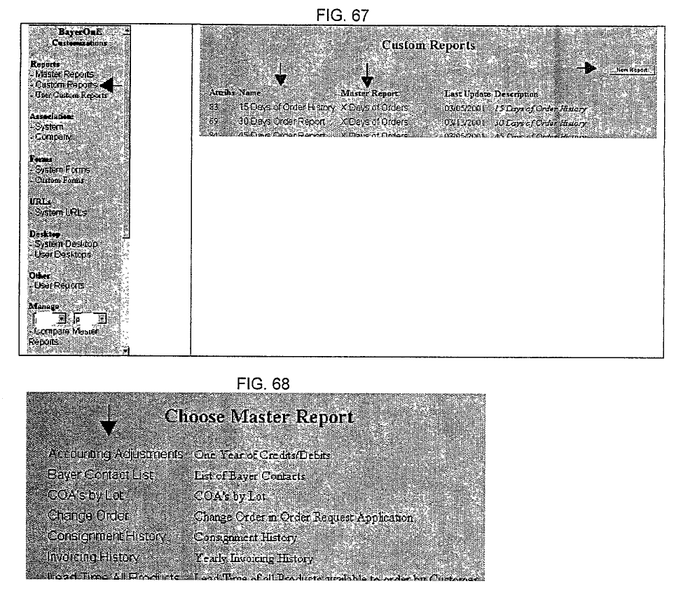

To Create a Custom Report, click on the custom link in the SecureNET Header the BayerONE application Link then the Custom Reports link on the left side (see FIG. 67).

To Edit an existing Custom Report, click on the link under the column header Name (see Arrow 1 in FIG. 67).

If you wish to see a Master Report that a particular Custom Report is associated with, click on the link under the column Master Report (see Arrow 2 in FIG. 67).

To create a new Custom Report, click on the New Report button in the right corner (see Arrow 3 in FIG. 67).

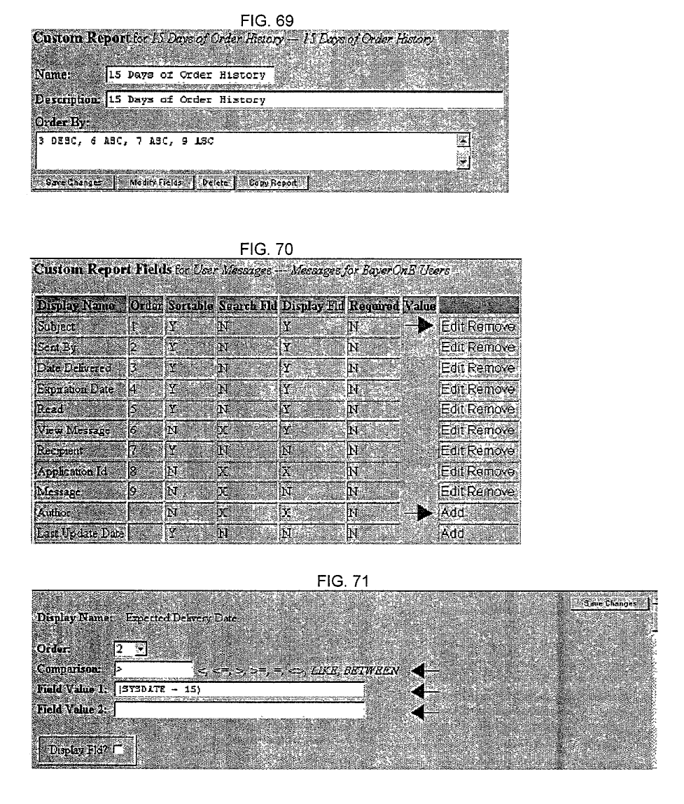

All Custom Reports are based on a Master Report. Custom Reports are one type of report that can appear on a user Desktop in BayerONE. Select the Master Report you wish to customize. See FIG. 68.

If creating a new Custom report, a page will appear like the one in FIG. 69, except all editable fields have no values in them. If a Custom Report is being edited, the fields will be populated with the values that were entered for that report.

Name: The name of the Custom Report is the name that, if the report is published, will be the title of the BayerONE report.

Description: The Description will be displayed alongside the Name in the BayerONE application on the Search Page (if there is a Search Page for that report) and alongside the report title on the actual report page.

Order By: Order By in the Custom reporting module sets the sorting order for the report within BayerONE. Refers to the field order number within the Custom Report.

This Order By field will override any Order By set in the Master Report, but it will not override a header field, if one is defined on the Master Report.

The Custom Report Order by will be tacked on behind any header field. In the example above, the Oracle® ASC and DESC are used for ascending and descending order.

This Order By will be the default on the Report within BayerONE. If a user tries to customize a report, they can override those for their newly-created custom report (My Report header on the BayerONE desktop is where any user customized reports will be located).

Save Changes: Will save the changes made on this page only, and if the report is a new Custom Report, that report will be created in SecureNET.

Modify Fields: Opens the page, Custom Report Fields main page. It gives a summary of the fields in the Custom Report.

The order the columns will appear on the BayerONE report.

If the column is sortable or not in BayerONE.

If the field is designated as Search Field for BayerONE. Any field designated as a search field will show up on the Search Page for the report before the report is generated.

If the field is displayed on this report in BayerONE.

If the field is required to be in the SQL for the BayerONE report.

Value is any additional information for the SQL's WHERE clause.

When coming to this page for the first time, on the far right side, all the rows will have a blue ‘Add’ link (Arrow 2 in FIG. 70). Each row must be added. If editing an existing report, the options will be Edit and Remove (Arrow 1 in FIG. 70).

Edit takes the user to an edit page to change the column properties for the Custom Report, thus changing the column's properties and functions for the BayerONE report.

Remove does not delete the column, it changes the link on the right to Add. Since all columns should be added, this really shouldn't be used at this time.

Order: This sets the display order for the BayerONE report.

Content is determined from the column options given to this particular column in the Master Report. The Product column was given search and display field options. If these options are not checked in the Custom Report, they will not take effect in the BayerONE report. This is the area where certain Master Report attributes can be overridden for this particular Custom Report. In FIG. 71, the Expected Delivery Date was only given the display field attribute and cannot be used as a search field in the BayerONE report. If one wishes to change this, they will have to go to this field in the Master Report.

Comparison and Field Value #:

These two fields help allow one Master Report to have many different reports based on it by adding to the WHERE clause. The example above, the Expected Delivery Date field from the 15 Day Order illustrates this point.

The information from the Comparison and Field Value # is used to construct a condition that is tacked onto the SQL statement's WHERE clause for this particular Custom Report when run in BayerONE. The only columns that can be put in the WHERE clause at this stage are columns defined in the Master Report.

When this type of statement is constructed in the BayerONE reporting module, the column name used in the SQL WHERE clause is taken from the Master Report Form Field's Field SQL for the column.

Comparison: This is the operand used for this portion of the WHERE clause. The following values are valid =, <, <=,>,>=, <>, LIKE, BETWEEN.

Field Value 1: The static value you wish to compare with the column.

Field Value 2: This would only be used if the Comparison value is BETWEEN.

It is also a static value.

In the 30, 45 and 60-day Custom reports, the Expected Delivery Date Field Field Value 1 is changed to make each of them a unique report. They are all using the same Master Report, but the SYSDATE—15 is changed to SYSDATE—30, SYSDATE—45 or SYSDATE—60 to give different result sets when run in BayerONE.

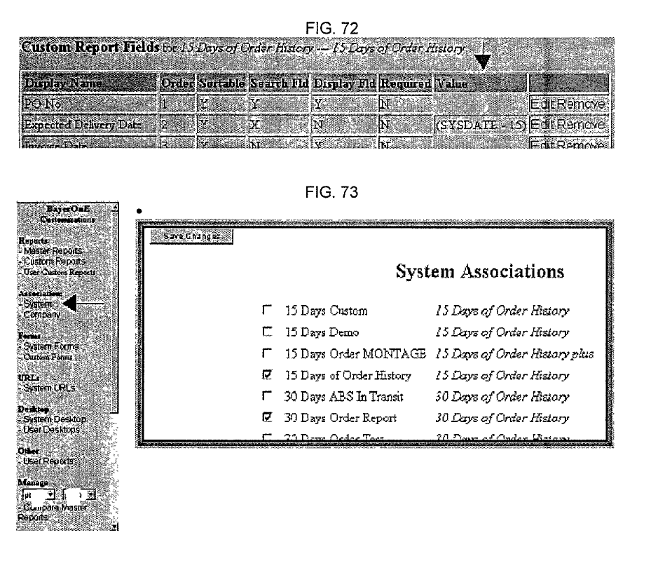

When a column in a Custom Report has a value associated with it, this will be indicated on the main Custom Report fields page for that report. See FIG. 72.

Now the Custom report is complete. The report needs to be made a system report and published to the customer's desktop.

The first step is to make the Custom Report a System Report for the BayerONE application.

To do this, click on the System link under the Association header (see FIG. 73). This will open up a page called System Associations (see FIG. 73).

All the reports that have been created against this database will be listed on this page, including personal Reports BayerONE users have configured for their own desktops (report that will appear under the My Reports header for a BayerONE user).

By checking a report, this is the step allowing the custom report to become a system report, a step in making it to the desktop.

Once the report(s) is(are) checked, click on the Save Changes button.

Now the report is a system report.

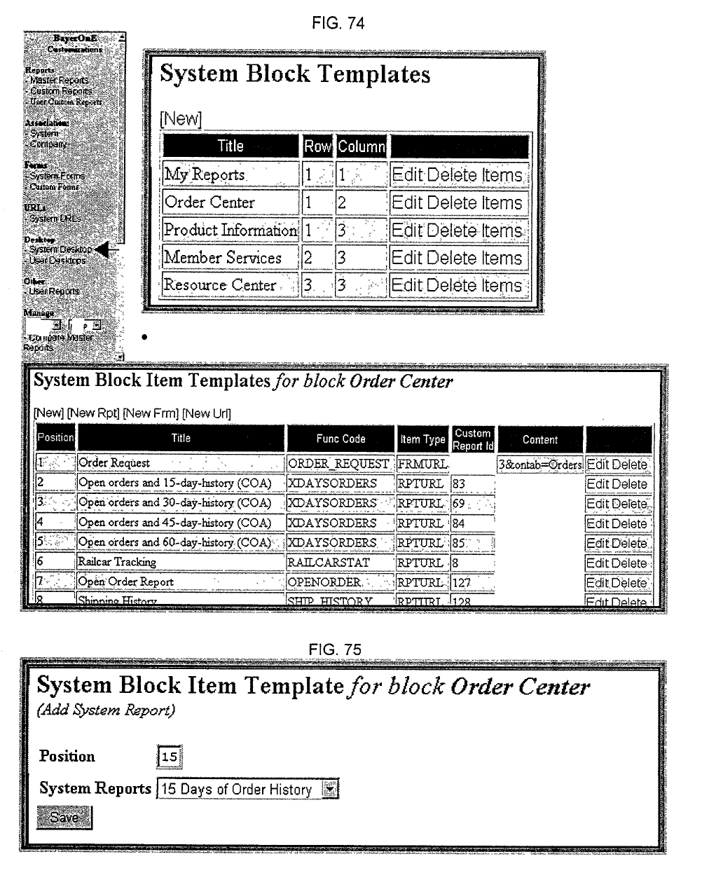

The next step to add a system report to a user's desktop is to add the report to the system desktop. See FIG. 74.

To do this, click on the System Desktop link under the Desktop. This will open up a page called System Block Templates (see FIG. 74).

This page shows the current headings on the BayerONE desktop. Each of these headings can be Edited, Deleted or new Items can be added by clicking on the Edit Delete Items links. Clicking on the [New] link near the top left can also create a new heading. The Edit Delete and New are discussed later in this document.

To add a system report, click on the Items link to the far right of the template where the report is to be located.

This page shows the attributes of system block items.

Position is the position of the item on the desktop (In the above example, Order Request will be the first report listed under the header, Open Orders and 15-day history will be the second).

Title is the title of the item on the desktop.

Function Code is the function code of the report, form or URL.

There are four different item type codes that will appear. These are assigned when a report, form, or URL is made into a system item created. Column function types are created by direct insert into the database. FRMURL is form URL, RPTURL is a report and URLURL is a URL.

This page allows the items within a block on the system desktop to be edited, deleted or new items to be added.

To edit an item, click on the Edit link on the far right side. The page that appears will be the same as the one that appears when a new item is added, except it will be filled with the item's data.

To delete an item from the template, click on the Delete link on the far right.

To add a new report, click on the [New Rpt] link near the top left. See FIG. 75.

Position: Is the placement position within the template, in this case the Order Center template.

System Reports: This dropdown contains all system reports. Choose the report you wish to place on the system desktop. Then click the Save button. This new item will appear in the System Block Item Template page for Order Center.

Other items that may be added to a desktop include Forms, which are stand-alone servlets typically who's SQL is too complex for the reporting module and URL, which are URL's to other sites that may be of interest to our customers. Servlets can be added as System Forms under BayerONE Customization, the Forms header System Forms.

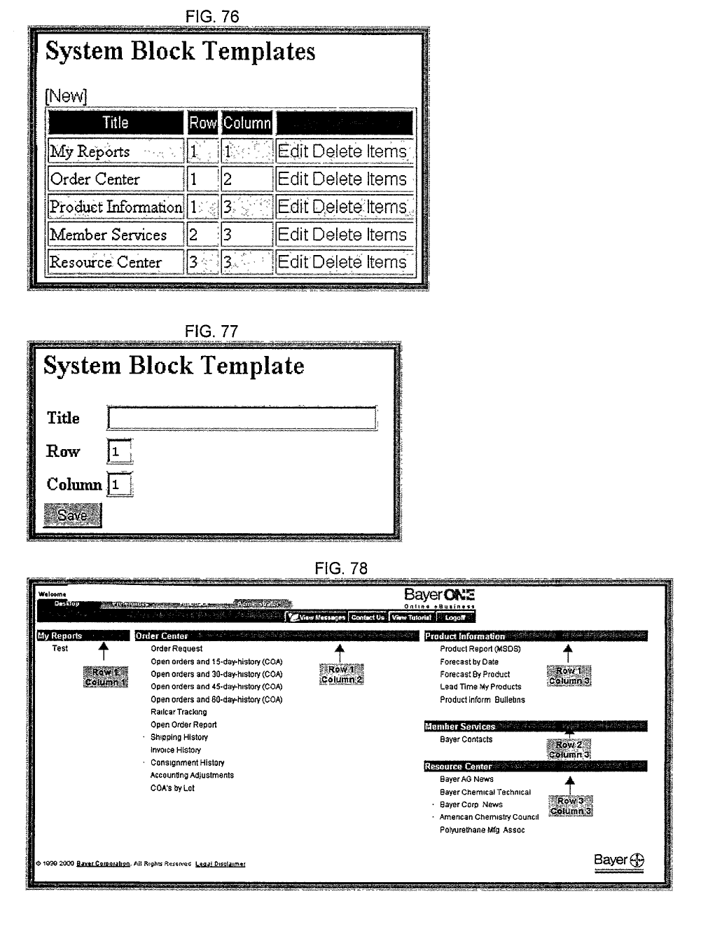

To add a new system block to the system template, click the [New] link. See FIG. 76. To edit a system block, click the Edit button. See FIG. 77.

Title: The title displayed on the desktop, The white text with the blue block background. (Example My Report header, Order Center . . . )

Row and Column: This is the position on the BayerONE desktop. See FIG. 78.

The final step to get a System Report on a customer's desktop is to publish a report. This can be done either by IT or e-business managers.

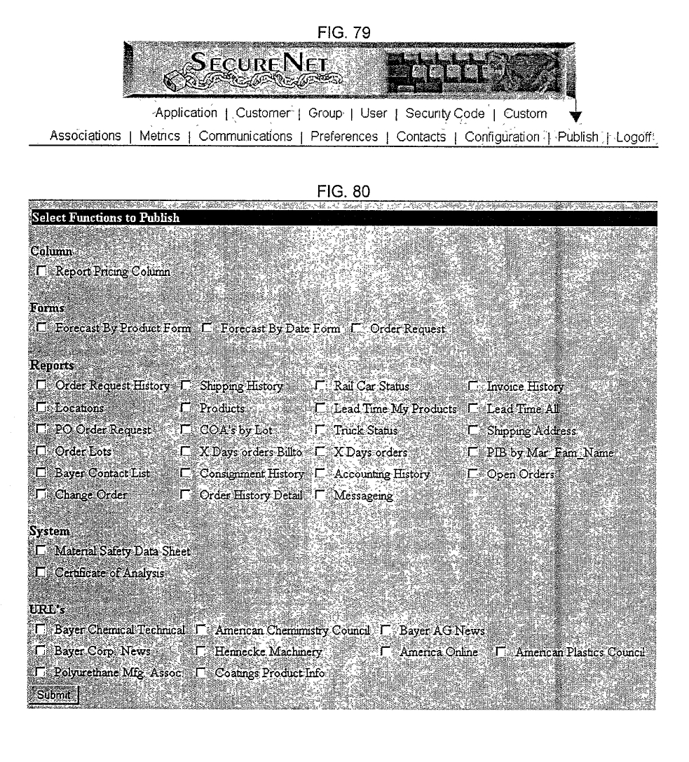

To publish a System Report click on the Publish link in the SecureNET header. See FIG. 79.

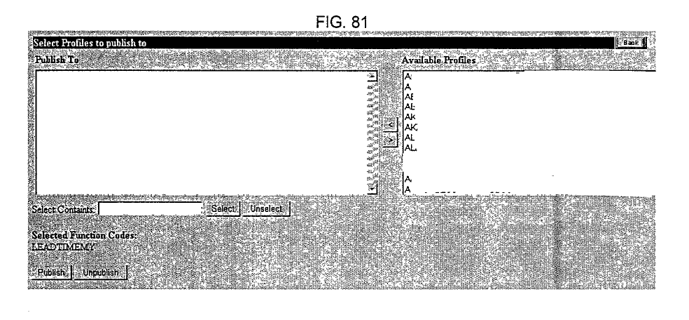

FIG. 80 illustrates the page where the items available for publishing are available. Please notice in the Report section, the titles of the Master Report Function code are listed and not Custom Reports. When a Master Report Function code is published, all Custom Reports that are System Reports are available to the desktops to which they are published.

Other items that need to be published to appear (or be used) on BayerONE desktops are Columns (currently the only one available is Report Pricing Column which is explained in the Master Report Form Field section Function Code), Forms, System and URL's.

Check an item to publish, then click the Submit button at the bottom. It will take you to the screen illustrated in FIG. 81.

Select from the Available Profiles section the companies you wish to publish to by clicking on the item (ctrl click for multiple items) the < button.

The Select Constraints edit box allows one to enter in a company name, part of a name, a profile type (Purchasing, Dock Worker etc). or a division, then click on the Select button and all items from the Available Profiles list will be moved to the Publish To list. The Unselect button will move ALL items in the Publish To list back to the Available Profiles list.

The > button will move selected items from the Publish To to the Available Profiles list.

The Publish button at the bottom will publish the function code listed above. The Unpublish function will unpublish the selected function code.

Publishing and unpublishing function codes place items to and remove items from desktops. When this occurs, the user desktops are deleted. What this means is the record for all users that are affected by the change will be deleted from bayerone.desktop_base. The next time the user logs onto BayerONE, their desktops are recreated and the new item will appear. This can be done manually by going to BayerONE Customizations, Desktop header and User Desktop link, clicking on the checkbox next to the user's id then clicking on the delete button at the bottom of the page.

URL Customization

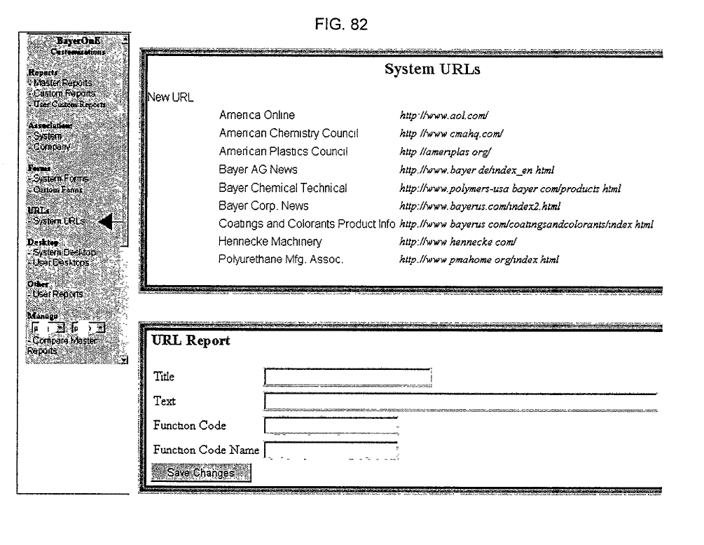

The URL Customization section allows us to add URL's to the BayerONE desktop that we feel will be of use to our users. See FIG. 82.

Clicking on the System URL link in the BayerONE Customization section opens a page where all the current System URL's are located.

To edit an existing one, click on the blue URL name.

To create a new URL, click on the New URL link near the top left.

FIG. 82 illustrates the page that will appear to add a new or edit the URL.

Title: This is how the link will appear on the Desktop.

Example: Yahoo

Text: The actual URL.

Example: http://www.yahoo.com

Function Code: Used as a unique representation of this URL.

Function Code Name: This is what is shown on the Publish page to publish the URL's function code, which will publish the URL.

Creating System Forms

Forms are reports that have SQL's too complex for the Reporting module (for example: UNION statements). They must be created as a separate servlet.

Currently a way for a form to appear on a desktop is to create a System Form then place it in a Desktop template (discussed above) and then publish the form's function code, which is created at this step.

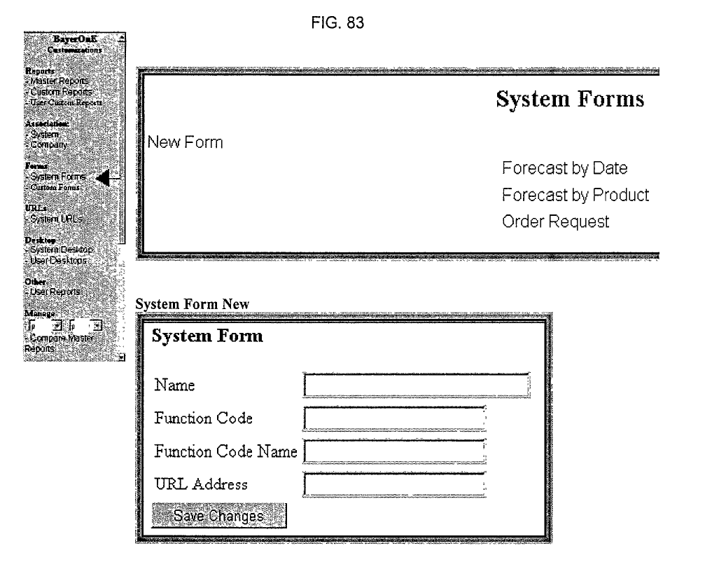

To create a new System Form, go to the BayerONE Customizations section and click on System Form. See FIG. 83.

A form can be edited by clicking on the link, which is the form name in blue. This allows you to edit only the Name of the form at this time. To create a New form click on the New Form link near the top left.

The New Form link will open up a page as illustrated in FIG. 83.

Name: The Name of the Form

Function Code: Used as a unique representation of this URL.

Function Code Name: This is what is shown on the Publish page to publish the Form's function code, which will publish the Form.

URL Address: The location within the BayerONE application of the form's servlet. This will also include any parameters that need to be passed. The parameters must be static.

Report Manager

Report Manager helps to manage the content of reports across databases. It visually displays differences between Master, System and User Reports and is a very useful tool when moving reports from test to production.

First select the database(s) you wish to compare.

To access these tools, click on the links in the BayerONE Customization section.

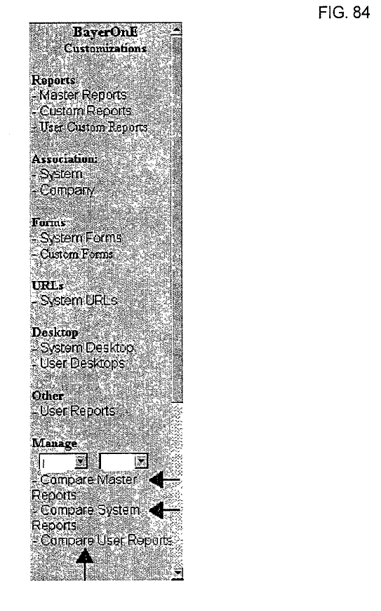

Arrow 1 in FIG. 84 is pointing to the tool that compares Master reports.

Arrow 2 in FIG. 84 is pointing to the tool that compares System Reports.

Arrow 3 in FIG. 84 is pointing to the tool that compares User Reports.

Overall, the method of the present invention is a computer-implemented system that is capable of presenting disparate buyer data to the authorized buyer, while maintaining complete security in any buyer-specific data between and among the individual buyers. The present invention provides, from the seller to the buyer, on the buyer network, the ability to determine each individual buyer user functionality and data access levels. Regardless of the functionality and data available to any individual user, every user is provided with data management tools, and a direct and dynamic link to the selected data. The present method, as implemented, is fully dynamic and versatile in its application. The user may customize the data and its presentation in a fully customizable form. While the method of the present invention can be effectively implemented in any language, in a preferred embodiment, the method is implemented in Java. In addition, the present invention is capable of handling extensible Mark-up Language (XML) transmissions for relieving and processing transactions (e.g., customer purchase orders). The XML standards can be established in accordance with current and emerging Chemical Industry Data Exchange (CIDX) standards as well.

This invention has been described with reference to the preferred embodiments and examples presented herein. Obvious modifications and alterations will occur to others upon reading and understanding the preceding description. It is intended that the invention be construed as including all such modifications and alterations.

We claim:

1. A computer-implemented method for maintaining a business relationship between a seller and a buyer, comprising the steps of:
a) providing a central database of information that contains disparate buyer data on a seller network;
b) establishing a buyer access level function on a seller network, wherein the buyer level function allows the seller to provide a buyer with access to a set of buyer data and a set of buyer functions for structuring the set of buyer data;
c) establishing a gatekeeper level function that allows the provision of a gatekeeper buyer contact point on a buyer network with the set of buyer data from the database and the set of buyer functions; and
d) establishing a buyer subordinate level user function that allows the provision of a buyer subordinate level user contact point that provides a buyer subordinate level user with access to selected buyer data from the set of buyer data and selected functions from the selected buyer functions at the buyer subordinate level user contact point.

2. The method of claim 1, wherein the buyer is a plurality of buyers, each buyer having associated disparate buyer data.

3. The method of claim 1, wherein the database contains predetermined seller data and buyer-specific data.

4. The method of claim 3, wherein the buyer-specific data is information relating to the relationship and transactional occurrences between the seller and the buyer thereby defining an event between the seller and the buyer.

5. The method of claim 4, further comprising the steps of:
e) selecting an event to be defined;
f) selecting corresponding selected buyer data for defining the event;
g) formatting the corresponding selected buyer data in a presentable report; and
h) presenting the report to the buyer.

6. The method of claim 5, wherein the buyer selects the event to be defined.

7. The method of claim 1, wherein, in step b), the set of buyer data and the set of buyer functions for structuring the set of buyer data includes reports generatable by a relationship framework functionality;
wherein, in step c), the set of buyer functions includes reports generatable by the relationship framework functionality; and
wherein, in step d), the selected functions from the selected buyer functions includes reports generatable by the relationship framework functionality.

8. The method of claim 1, wherein the central database is resident on the seller network and individual data fields are resident on various discrete seller computing systems that are in a networked relationship, such that the central database has access to the data stored in and available from each discrete seller computing system.

9. The method of claim 1, wherein the central database includes relational tables resident on the seller network and associating each individual data field and each linked group of data fields.

10. The method of claim 1, further comprising the step of:
e) associating the disparate buyer data with the respective buyer through a common buyer link field, such that buyer-specific data is created via the common buyer link field.

11. The method of claim 10, wherein the common buyer link field is a seller-assigned customer number.

12. The method of claim 1, wherein the central database is updated on a real-time basis.

13. The method of claim 1, wherein the central database is updated on a periodic basis.

14. The method of claim 1, wherein the buyer is a corporate entity and the buyer subordinate level user is an employee of the corporate entity.

15. The method of claim 1, wherein the gatekeeper level function defines a gatekeeper role on the buyer network.

16. The method of claim 15, wherein the gatekeeper is one of a seller system administrator, a buyer system administrator, and a buyer employee.

17. The method of claim 1, wherein at least one of the selected buyer functions is the ability to define a customized format in which the subordinate level user would like the selected buyer data to be presented.

18. The method of claim 1, wherein the buyer subordinate level user contact point is a personal computing machine networked with other personal computing machines on the buyer network.

19. The method of claim 1, further comprising the steps of:
e) creating a plurality of buyer subordinate level users; and
f) associating at least two of the buyer subordinate level users together, thereby defining a group including the at least two buyer subordinate level users.

20. The method of claim 19, wherein the at least two buyer subordinate level users are associated by one of buyer subordinate level role, buyer subordinate level responsibility, buyer subordinate level location and buyer subordinate level title.

21. The method of claim 1, further comprising the step of:
e) associating, by the buyer subordinate level user at the buyer subordinate level user contact point, a subset of the selected buyer data using the selected buyer functions.

22. The method of claim 21, further comprising the steps of:
f) contacting the central database on the seller network by the buyer subordinate level user at the buyer subordinate level user contact point;
g) gathering, by the central database, the most current subset of the selected buyer data;
h) routing the most current subset of the selected buyer data to the buyer subordinate level user at the buyer subordinate level user contact point.

23. The method of claim 1, further comprising the step of:
e) modifying the selected buyer data for the buyer subordinate level user by the gatekeeper level function at the gatekeeper buyer contact point on the buyer network.

24. The method of claim 1, further comprising the step of:
e) modifying the selected buyer functions for the buyer subordinate level user by the gatekeeper level function at the gatekeeper buyer contact point on the buyer network.

25. The method of claim 1, further comprising the step of:
e) restricting, by the buyer subordinate level user at the buyer subordinate level user contact point, a subset of the selected buyer data using the selected buyer functions.

26. The method of claim 1, further comprising the step of:
e) presenting the selected buyer data and selected buyer functions to the buyer subordinate level user at the buyer subordinate level user contact point.

27. The method of claim 1, wherein steps b)-d) are completed in a discrete period of time.

28. The method of claim 24, wherein the discrete period of time is in the range of about 1 minute to about 10 minutes.

29. An apparatus capable of performing the method according to claim 1.

30. A computer-implemented method for maintaining a business relationship between a first entity and a second entity, comprising the steps of:
a) providing a central database of information that contains disparate second entity data on a first entity network;
b) establishing a second entity access level function on a first entity network, wherein the second entity level function allows the first entity to provide a second entity with access to a set of second entity data and a set of second entity functions for structuring the set of second entity data;
c) establishing a gatekeeper level function that provides access at a gatekeeper second entity contact point on a second entity network to the set of second entity data from the database and the set of second entity functions; and
d) establishing a second entity subordinate level user function at a second entity subordinate level user contact point that provides a second entity subordinate level user with access to selected second entity data from the set of second entity data and selected functions from the selected second entity functions at the second entity subordinate level user contact point.

31. The method of claim 30, wherein the second entity is a plurality of second entities, each second entity having associated disparate second entity data.

32. A computer-implemented method for maintaining a business relationship between a seller and a buyer, comprising the steps of:
a) providing a central database of information that contains disparate buyer data on a seller network;
b) establishing a buyer access level function on a seller network, wherein the buyer level function allows the seller to provide a buyer with access to a set of buyer data and a set of buyer functions for structuring the set of buyer data, wherein the set of buyer data and the set of buyer functions for structuring the set of buyer data includes reports generatable by a relationship framework functionality comprising (1) a report relationship structure module field that defines generic features of events that are expected to occur in a relationship between a buyer and seller, and (2) at least one database, electronically connected to the report relationship structure module field for providing content for defining specific features of a specific event that actually occurs between a buyer and a seller;
c) establishing a gatekeeper level function that allows the provision of a gatekeeper buyer contact point on a buyer network to the set of buyer data from the database and the set of buyer functions, including reports generatable by the relationship framework functionality; and
d) establishing a buyer subordinate level user function that allows the provision of a buyer subordinate level user contact point that provides a buyer subordinate level user with access to selected buyer data from the set of buyer data and selected functions from the selected buyer functions at the buyer subordinate level user contact point, including reports generatable by the relationship framework functionality.

33. The method of claim 32, wherein the buyer is a plurality of buyers, each buyer having associated disparate buyer data.

34. The method of claim 32, further comprising the step of:
e) associating the disparate buyer data with the respective buyer through a common buyer link field, such that buyer-specific data is created via the common buyer link field.

35. The method of claim 32, wherein the central database includes relational tables resident on the seller network and associating each individual data field and each linked group of data fields.

36. The method of claim 32, wherein the central database contains predetermined seller data and buyer-specific data, wherein the buyer-specific data is information relating to the relationship and transactional occurrences between the seller and the buyer thereby defining an event between the seller and the buyer.
